(19) United States
(12) Patent Application Publication
(10) Pub. No.: US 2004/0121820 A1
(43) Pub. Date: Jun. 24, 2004

(54) Outer mirrors

(75) Inventors: Noriyuki Unno, Shizuoka (JP); Tohru Yamana, Shizuoka (JP); Akira Fukai, Shizuoka (JP); Masaaki Matsuura, Shizuoka (JP); Masahiro Motomiya, Shizuoka (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MURAKAMI CORPORATION, Shizuoka-shi (JP)

(21) Appl. No.: 10/722,489

(22) Filed: Nov. 28, 2003

(30) Foreign Application Priority Data
Dec. 20, 2002 (JP) 2002-369699
Dec. 20, 2002 (JP) 2002-369753
Dec. 20, 2002 (JP) 2002-369879
Dec. 20, 2002 (JP) 2002-369868
Dec. 20, 2002 (JP) 2002-369772

(51) Int. Cl. H04Q 7/20

(52) U.S. Cl. 455/569.2

(57) ABSTRACT

The outer mirror comprises a mirror housing and a mirror base which suspends the mirror housing that has a mirror. Antenna unit, a monitoring camera, light sensors and plural mirrors are installed in the mirror base so that various functions are realized using this outer mirror as well as carrying out easy assembling process and good serviceability.

### FIELD OF THE INVENTION

This invention relates to an outer mirror (defined as the mirror set close to the driver cabin such as a side mirror and pillar mirror, etc.) and ancillary automobile equipment which is used for the application of the outer mirror. More specifically, the present invention relates to an outer mirror, a automobile application of the outer mirror, an automobile visual surrounding monitoring device for safety monitoring of the back side of an automobile and an anti-glaring outer mirror which has anti-glaring effect provided by using EC (Electrochromic) film.

### BACKGROUND OF THE INVENTION

Various communication technologies have been recently applied to ITS (Intelligent Transportation System), more specifically GPS (Global Positioning System), VICS (Vehicle Information and Communication System), ETC (Electric Toll Collection System) etc.

In order to use these technologies and obtain the services given by using these technologies, antennas for transmitting and receiving high frequency radio waves are the essential components as well as other cooperating electronics devices installed in automobiles. The suitable place for the installation of antennas may be on the roof or the trunk of automobiles since the transmission and receipt of radio wave are less affected for the antennas attached to these places. However, the attachment of an antenna to these places damages the outlook of the automobile and spoils the automobile apparent design and it is, in many cases, a practical installation of antennas such that they are placed close to dashboards and windows. Since each electronic device to obtain specific services needs an antenna, plural antennas are attached to a dash board, windows or adjacent places. This tends to spoil the interior design, particularly, the outlook of dashboard and adjacent portion.

On the other hands, infrared light absorption and reflection glasses have been recently used for the widows of high-end commercial automobiles and therefore the radio wave is hardly received in the cabins of such automobiles. In order to solve this issue, it has been proposed to install the antennas in the outer mirrors.

FIG. 9 shows a conventional installation method of an antenna into an outer mirror. As shown in the figure, two antenna units 2a, 2b are set in different directions. The mirror housing is mounted to a mirror base 3 and can be rotated therewith. The rotational movement is designed to be associated with the housing motion and the resetting motion of the mirror. Since the two antenna units 2a and 2b are exchangingly switched against the rotational motion of the mirror, it is designed that either one of the antennas is selected and can receive radio wave regardless to the status of the mirror; being housed or being reset.

FIG. 10 shows another conventional mirror antenna, where a mirror housing 1 is attached to and can be rotated on a stage 31 which is set onto the mirror base 3 and the antenna 4 is attached to a stage 3a with no rotational motion allowed. In this construction, the mirror housing 1 can be rotated as the antennas 4 attached to the stage 3a (see paragraphs 0024-0029 and 0050-0051 and FIG. 1 and 11 of Published Japanese Patent Application: JP, 11-321471, A (1999)).

Another conventional technology is shown in FIG. 11. This construction is that the antenna unit is directly attached to a stage 5a set onto the mirror base 3 and a drive unit (not drawn in FIG. 11) is set on the antenna unit on top of which mirror housing is installed with rotational motion allowed therein. Therefore, the construction is made in a form that antenna unit 6 is attached to the stage under the drive unit and mirror housing (see pp. 12-13 and FIG. 7 (B) of Published Japanese Utility Model Application: U, S62-89815).

However the above conventional outer mirrors have the following problems. The antennas 2a and 2b as shown in FIG. 9 are set in the mirror housing 1 and therefore wire harness is set to run from the drive unit (which is not drawn in the figure) through a shaft of the drive unit set in the mirror housing 1 to the mirror base 3 because a shielded construction of the mirror housing is required for high durability against the harsh outdoor environment. Since the drive unit and the mirror assembly mechanism need wire harness for their electrical driving, the shaft of the drive unit has to accommodate to have the wire harnesses necessary other than the antenna harness. The through hole formed in the shaft of the drive unit is not so large enough such that all harnesses run therethrough. Therefore the fine wires have to be used for the harnesses for the antenna unit 2a and 2b. Therefore the radio signal to or from the antenna unit tends to decay and may be broken in the vibrations.

From these aspects, the outer mirror as shown in FGI. 10 has the antenna directly set onto the stage 3a of the mirror base 3 and therefore the use of thin wires for harnesses that run through the through hole in the shaft is not required and there are no similar problems as discussed above. However the whole antenna unit 4 is set in and covered by the mirror housing 1 and therefore the transmitting and receiving of the radio wave are barriered off by the mirror housing 1 if it is made from electrical conductive materials, for example the mother material of the mirror housing is a plastic but the surface is covered by a metal plating. The mirror housings of which surfaces are covered by the metal plating have recently been becoming popular especially for RV (recreational Vehicle) automobile. Therefore the antenna unit 4 is not applicable for such automobiles. When the antenna unit 4 is used for the mirror housing, then no metal plating can be done on the surface of the mirror housing 1.

Electrically housing outer mirror has the general construction such that the mirror housing can rotate by a drive unit set on the stage extended from mirror base and the mirror is selectively set to the status; being housed or bring reset. It is difficult to set an antenna unit 4 in the stage 3a of the mirror base 3 since there is no enough room left in this construction and laborious assembly is required.

For the construction of the outer mirror as shown in FIG. 11, the antenna unit 6 is attached to the stage under the drive unit and the mirror housing and therefore the transmitting and receiving of the radio wave are barriered off by the mirror housing 1 if the surface is covered with metal plating. Moreover, if metal material is used for the drive unit which is locates on the antenna unit 6, the metal material works a reflecting plate and the radio wave transmitting and receiving is not properly done.

This invention is proposed to solve such a problem and realizes a normal radio wave transmitting and receiving. Therefore, the setting of wire harness has more freedom in assembly, the handwork for the assembly is easy, and effectiveness of the antenna unit is not reduced for the metal plated mirror, resulting into the use of the outer and the automobile application of the outer mirror.

For the general commercial automobiles, a back mirror installed in the front are of the driver cabin and the outer mirror (especially called door mirrors) installed onto the front doors are used for monitoring and safety checking of the back side. The outer mirror comprises a mirror base which is fixed to an outer panel at the triangle area between the lower window frame and a mirror housing fixed to the mirror base.

Drivers use these outer mirrors for the purpose of safety confirmation of the backward drive in backward direction and the right-back and left-back directions and that in right and left turning. However there are dead view angles in using these outer mirrors and there are possibilities of traffic accidents against the peoples walking close to the automobile driven by the driver who cannot be aware of the presence of the walking person. In order to monitor the place in the dead view angles for the outer mirrors, the conventional technologies (see Published Japanese Patent Applications: JP, 2001-130323, A) have been proposed wherein viewing cameras, having different viewing angles, are attached to the cabin and/or the outside of automobiles beneath the mirror bases in addition to the outer mirrors with a freedom in the rotational motion. Therefore, the driver can monitor the views which are not obtained by the outer mirrors, for example the views from the low angle from the automobile bodies. Another implementation of such technologies is to install viewing cameras in the mirror housing which can be rotated for searching and monitoring at the dead view angle (see Published Japanese Patent Applications: JP, 2001-130324, A). Another implementation is to install the viewing cameras in the mirror housing to monitor the forward side which is another dead viewing angle for the monitoring by the outer mirrors (see Published Japanese Patent Applications: JP, 2000-62531, A).

However, the camera installation into the automobile body may make the assembly process of the automobile complicate and the replacement service of the viewing cameras is difficult when the cameras are in trouble.

The viewing cameras attached to the automobiles beneath the out mirrors have a view angle lower than that of drivers. Therefore a problem is still left, that is, it is difficult to provide the viewing cognition at the same height of drivers' eyes.

The installation of the viewing cameras into the mirror housing needs the electric power supply to the viewing cameras for which the wire harness is set through the hole formed in the shaft of mirror drive. However the quantity of wire harnesses running through the hole is limited by the inner diameter of the hole. Therefore the additional harnesses for the purpose of the viewing camera may sacrifice the other harnesses necessary of realizing the other functionality of the outer mirrors and may need additional laborious assembly works to put thin wire cabling.

Another aspect of the problems is that the mirror housing is necessary to be rotated for every shot of views in addition to the complicate construction of the mirror housing. Therefore the drivers can see only the views of the shots that the cameras have taken during the rotation of the mirror housing. The image of the shot taken by the camera installed in the mirror housing has lower positional viewing angle than that of drivers' sight and therefore the images are not obtained by the obstruction of other automobiles since their bodies and/or the doors obstructing to the viewing cameras when the automobiles are running of parking in parallel.

The viewing cameras installed in mirror housing to monitor the forward side causes the complicate construction of the mirror housing and viewing angles are confined into such forward side of the automobiles. Therefore it is difficult to monitor the scenes in various the dead viewing angles.

In order to solve these various problems, the present invention is to provide a new device that is a surrounding area monitoring device attached to the mirror base without a complicate construction necessary for the case of the camera installation in the mirror housing, wherein the monitoring device can take the scenes in wide range of views at the level of drivers' viewing sights even those in the dead viewing angles in the forward side and backside.

For the use of the inner mirrors and outer mirrors, it some times happens that drives feel glaring of the dazzling head lights of the other automobiles running in the back side and those reflected by inner mirrors and outer mirrors. This is caused by the following phenomenon such that the reflected light of the head lights of the automobiles running in the back side goes into the drivers viewing angles and has larger intensity than the scattered lights of the head lights on the surface of the inside of the cabin that goes into the drivers view angles. Therefore EC (Electrochromic) film formed on the surface of the outer mirrors and the inner mirrors reduce the effect of glaring in the reflection which is called “anti-glare effects”. The effect is obtained by the electric current flow in the EC film and then the film turns into colored and reduces the reflectivity. The electric current is controlled by the signal of the sensor to detect the surrounding light (called “a surrounding light sensor” hereinafter) which is mostly the scattered light of the direct head light emitted by the automobiles following in the back of the automobile and excludes the direct head light by the signal of the sensor to detect the direct head light at the back side of the automobile (back side light sensor) emitted by the automobiles running back side. An example of such control is that the coloring of the EC film is increased as far as the direct head light at the back side relative to the scattered light becomes large. The increase of coloring reduces the reflectivity of the mirror that results in the increase of anti-glare effects. The surrounding light sensor and the back side light sensor are installed in the mirror housing of the inner mirror. These sensors control the inner mirror and the outer mirror.

Since the sensors are installed in the cabin, the scattered light and the back side light are detected through the windows of the automobile and the detection is done apart from the outer mirror, the signal is not sufficient for use of controlling the reflectivity. Since privacy protecting glasses are used, the glaring in the reflection less happens. However the discharge bulbs (or called “HID”) are widely used and therefore it is necessary to suppress the reflection at the outer mirror. For this purpose an EC automatic anti-glare outer mirror that has and independent automatic anti-glare effect. For an actual installation, the examples of the location of installation of the surrounding light sensor and the back side light sensor are described as follows;

1) the surrounding light sensor and the back side light sensor are installed into the mirror housing of the outer mirror (see paragraphs (0017) to (0050), FIG. 1 and FIG. 12 of Published Japanese Patent Applications: JP, 08-106110, A (1996))

2) the surrounding light sensor is installed closed to the outer mirror and the back side light sensor is installed in the mirror housing (see paragraphs (0017) to (0047) and FIG. 1 of Published Japanese Patent Applications: JP, 11-342790, A (1999)).

FIG. 23 shows the over view of and an example of the outer mirrors with EC automatic anti-glare described in Published Japanese Patent Applications: JP, 08-106110, A (1996). The EC automatic anti-glare outer mirror 221 comprises an EC mirror 222 and a mirror housing 223. The EC mirror 222 can control the reflectivity by the EC film formed on the surface of the mirror which is set in the mirror housing 223. A surrounding light sensor 224 and a back side light sensor 225 are set. The scattered light and the back side light are detected through two windows formed in the front and back side portions of the mirror housing, respectively.

Another example is that the EC mirror has a cut-off through which the back side light is detected by the sensor. An automatic anti-glare outer mirror proposed in the past patent (Published Japanese Patent Applications: JP, 11-342790, A (1999)) has the surrounding light sensor is not installed in the mirror housing 223 but in the portion close to the door mirror.

However the EC automatic anti-glare described in Published Japanese Patent Applications: JP, 08-106110, A (1996) has the following problems.

(A) The mirror housing 223 has an actuator (not shown in the figures) that adjusts the setting angle against the mirror housing, therefore there is no enough room to install the surrounding light sensor 224 and the back side light sensor 225 in the mirror housing 223 that causes the difficult assembly process of the outer mirror. The wire harnesses used for various component installed in the mirror housing 223 runs through the open hole formed in the shaft (not shown in the figures) supporting the mirror housing 223. Since the quantities of the wire harnesses are limited by the inner diameter of the open hole formed in the shaft, the increment of the wire harness due to the sensors needs to reduce harnesses used for other components installed in the mirror housing that results in the limited function of these components. Since the sensors are fixed to the open hole and the cut-off formed in the mirror housing 223 and the mirror 222, respectively, the light detection is not properly done as being designed in some orientation for the mirror housing against the automobile that may result in an insufficient anti-glare effect.

(B) When the back side light sensor 225 is set in the back side of the EC mirror 222, the viewing sight at a certain view angle is not obtained due to the presence of the cut-off formed in the EC mirror. An additional process for the EC mirror is required for such cut-off. Since the back side light sensor 225 is fixed to the mirror housing 223, an insufficient anti-glare effect as described in (A) is left as a problem.

Therefore a new automatic anti-glare outer mirror is required, wherein the light detection is possible without the influence of the direction of the mirror housing, no cut-off is necessary to be formed in the mirror and the installation and cabling of the harnesses are easy. The present invention has the advantages to satisfy these requirements.

### SUMMARY OF INVENTION

In order to solve the above problems and achieve the above technical purposes, the outer mirror according to the present invention comprises a mirror base extending from the automobile side and a mirror housing suspended by the mirror base wherein an antenna unit is installed in the mirror base.

According to such an outer mirror, the construction is that the outer mirror is suspended (called “upper suspension”, herein after) from the mirror base which extends from the automobile side and therefore the mirror base locates higher than the mirror housing does. Since the antenna unit is attached into this mirror base, the antenna is not covered by the mirror housing so that the mirror housing does not impede the transmission and receiving of radio wave by the antenna unit. Therefore less disturbed transmission and receiving of the radio wave can be realized. In addition the mirror base locates in higher position than that of the mirror housing and therefore metal plating to the mirror housing is accepted and has higher adaptation to various kinds of automobiles due to the good appearance of outlook design. Since the antenna unit is installed in the mirror base which extends to the side direction of the automobile, the length of the antenna harness can be short and cabling is easy that contributes to short assembling time.

In the outer mirror according to the present invention, the mirror base has an adjustment means of the antenna mounting angle.

Therefore the direction of the antenna can be set to the direction to which the antenna unit can strongly receive the radio wave signal and the high efficiency of radio communication is possible. Since it is possible to adjust the mounting angles of the antenna units, it is possible to mount various kind of antenna for this mirror base.

This outer mirror features to have a connector close thereto on the automobile wherein the connector can electrically connect the antenna unit to the system which needs the antenna.

Since one (called “a receptacle connector”) of the connector pair is attached to the potion of or the portion close to the mirror base installed to the automobile, it is the advantage of this invention that the installation of the antenna unit is easy work. When the receptacle connector is attached to the mirror base, it is possible to electrically connect the antenna unit in the mirror base that results in an easy maintenance service of the antenna unit. In addition, it is possible to easily add the antenna unit after the outer mirror assembling has been done.

The outer mirror according to the present invention features that the antenna unit is a multiple frequency band antenna to transmit and receive the radio waves over different frequency bands.

By using this outer mirror, plural on-vehicle devices, for example, ETC, GPS etc., are supported by a single antenna unit since the antenna unit is a multiple frequency band antenna.

Another feature of the outer mirror according to the present invention is that the mirror base comprises a base body to which the antenna unit is attached and an outer cover that covers the base body wherein the outer cover is made of radio wave transmittable material.

The outer mirror according to the present invention has an outer cover that covers the mirror body as well as the antenna unit and therefore good appearance can be improved by the outer cover. The transmittable material of the outer cover does not intrude the transmission and receiving the radio wave.

In addition, the outer mirror according to the present invention comprises a base body to which the antenna unit is attached and an outer cover that covers the base body, wherein the antenna has a sensitivity to receive the infrared light due to the higher order harmonics of the radio wave corresponding to the infrared light and the outer cover is made of the infrared light transmittable material or is finished by the material that allows the infrared light to transmit through the outer cover.

By using the outer mirror described above, a good appearance is obtained since the antenna is covered by the outer cover that covers the base body as well and the communication using infrared light such as VICS can be performed as an additional application.

In addition, the outer mirror that is applicable to the infrared light receiving, the inner surface of the mirror base is frost-painted and the scattering of infrared light is suppressed so that stable receiving of the infrared can be achieved.

The automobiles having the outer mirrors described above can transmit and receive the radio wave through both antennas installed on the right and left sides of the body.

Once a pair of antenna units is separated by a length comparable to the radio wave length, the difference of radio wave receiving characteristics can select the better receiving antenna and eliminate a radio wave interference made in the radio wave propagation. For example, a diversity receiving is possible by means of selecting one of the antennas based on the better receiving status. The mobile broadcast receiving for which two antennas are required is possible. In this case, a receiver system that has less interference of radio wave receiving is possible by making the reference length between two antenna units long in the installation in the automobile. To realize these capabilities, the automobile body width is used for the separation length of a pair of antenna units once they are installed onto the both sides of the automobile.

According to the present invention, the automobile that can have a separation length in setting a pair of the above outer mirrors on the right side and the other on the left side thereof can provide a good receiving characteristic of the antennas.

Moreover, in case when one of the antennas is broken due to a trouble of the automobile or a traffic accident, the other antenna can still work for transmission and receiving of the radio wave and therefore the emergency communication such as the communication to inform the location of the automobile is still possible. By installing two different antenna units for the right and left sides of the automobiles, different on-vehicle apparatuses can be simultaneously used and support various information handling by means of such apparatuses is possible.

In order to solve another conventional technical problem, the present invention provides an surrounding area monitoring device realized by a construction of the outer mirror which comprises a mirror base extending outward from the side of an automobile and a mirror housing suspended by the mirror base.

The surrounding area monitoring device according to the present invention has a construction such that a mirror housing is suspended by the mirror base called as an upper suspension outer mirror and the viewing cameras is installed in the mirror base. Then, the installation of the viewing camera can be simplified in comparison to a conventional assembling and construction problem, that is, the viewing camera is installed in the mirror housing with a complicate wire harness and construction. In addition, the viewing camera can monitor the surroundings and surrounding area at the similar height of the driver sight therefore it is possible to monitor the wider range than the camera of the conventional installation can support.

Therefore the areas which are in the dead view angles for the driver sight can be monitored and be checked for the safety by the monitoring camera installed in the mirror base so that it is possible to avoid the accident that happens in the turning and moving backward with lack of viewing check of the drivers in the range of the dead viewing angles. By keeping the mirror bases to which the viewing camera is installed in both sides of the automobile, it is possible to confirm the status of the surroundings when the outer mirrors are stored in the orientation inward the automobile and are housed. In addition, it is possible to confirm the presence of large vehicles such as trucks and traffic signals in the foresight beforehand by installing the surrounding area monitoring device. The scenes monitored by the viewing camera can be presented in the display which is set in the cabin. As an example, when the display is set on the front board on which a speed meter, fuel meter etc. are aligned, the driver can easily check the outside scenery and avoid the traffic accidents such as collisions.

The surrounding area monitoring device according to the present invention features to have plural viewing cameras in the installation.

It is possible to monitor not only a single direction of the viewing angle of the viewing camera but also a wide range of the surrounding area by the surrounding area monitoring device that has plural viewing cameras in the mirror base, so that the driver can easily and surely check the surrounding area by means of the viewing cameras. Of cause it is possible to arbitrarily change the direction of the viewing cameras for more specifically or carefully checking.

The viewing cameras of the surrounding area monitoring device according to the present invention feature to be installed to have a capability of arbitrarily rotation.

The surrounding area monitoring device according to the present invention has an upper suspension outer mirror that is the mirror housing is suspended by the mirror base. One or more viewing cameras are installed in the mirror base with rotation capability so that the driver can monitor the surroundings in the similar height of his or her sight and the wider range of surroundings than the viewing angle of his or her sight. Therefore the surrounding area monitoring device realized by the outer mirror can easily monitor the obstacles in the dead viewing angle by rotating the viewing camera. By this flexibility for the wide range of monitoring capability, the devices serve for preventing the accidents in turning and moving backward. The installation of the viewing cameras into the mirror base is a simpler process and needs less complicate wire harnesses than that into to mirror housing even the viewing camera has rotational motion capability. The viewing camera can operate and be usable when the outer mirror is housed to the direction of the automobile body.

The viewing cameras of the surrounding area monitoring device according to the present invention feature to be installed in the upper direction of the outer side of the mirror base.

The surrounding area monitoring device according to the present invention has a viewing camera installed in the upper direction of the outer side of the mirror base so that the viewing angle by the viewing camera is similar to that of the driver. Therefore it can be prevented such that viewing scenery is not blinded by the presence of bodies or doors of other automobiles parked in parallel. Therefore, it is possible to confirm the safety around the automobile since the height of the viewing camera is similar to the driver's sight Therefore the driver can confirm the status of traffic condition without illusion and can early be noticed of the presence of trucks, automobiles and traffic signals in the forward side.

The surrounding area monitoring device according to the present invention features to comprise a salient block that extends outward and is fixed to the side of the automobile and a viewing camera installed in the salient block.

The surrounding area monitoring device according to the present invention has the capability to visually confirm the wider range of viewing area by a construction such that the viewing camera is installed in the salient block that extends outward and is fixed to the side of the automobile than by the surrounding area monitoring device realized by the outer mirror. By using this implementation of the present invention, it is possible to visually confirm the wide range of viewing area even removing the outer mirror. The blinded area by the surrounding area monitoring device that is realized by the outer mirror due to the dead viewing angle can be monitored and the scene is taken by the viewing camera to display on the front board that facilitates the driver to visually check the surrounding area without diverting his sight much from the forward direction of the automobile. That prevents the accident of collisions. The salient block can be designed to be within the width of the automobile.

The salient block of the surrounding area monitoring device according to the present invention features to have plural viewing cameras.

The surrounding area monitoring device according to the present invention has plural viewing cameras in the salient block so that it is easy to check the safety of surrounding area as well as the back side and the right and left of the back side. It is possible to monitor the inside cabin by setting the direction of the viewing cameras so that the monitoring can serve for the prevention of crimes.

The surrounding area monitoring device according to the present invention features to can rotate on an arbitral direction.

The surrounding area monitoring device according to the present invention has a salient block extending outward from the sides of the automobile and the viewing camera is installed with rotational capability in the salient block. By arbitrarily rotating capability of the viewing camera, the driver can monitor the area he wants to check by rotating the viewing camera. The viewing camera may serve for the prevention of the crimes by setting the viewing direction to the cabin.

The surrounding area monitoring device according to the present invention can be constructed in such a construction that a recording means and an alarming means are installed in the automobile, by which the information of the image taken by the viewing camera is recorded as well as generates alarming sounds by the alarming means.

In this construction, it is possible to transmit the image taken by the viewing camera to a security manager or the owner through a communication means and generate alarming sounds when the driver finds a trouble in the automobile.

In order to solve another conventional technical problem, the present invention provides an automatic anti-glare outer mirror which comprises a mirror base extending outward from the side of the automobile body and a mirror housing, being mounted to the mirror base, to which an EC mirror is attached wherein a surrounding light sensor and a back side light sensor that respectively detect the surrounding light and back side light are installed in the mirror base and a control means equipped to control the reflectivity of the of the EC mirror.

In this construction, since the surrounding light sensor and back side light sensor are installed in the mirror base, the light detection is done without the influence of the orientation of the mirror housing. Therefore it is possible to detect the surrounding light and back side light in an optimum condition and a stable and less unpleasant anti-glare effect can be obtained. The back side sensor is set in the mirror base and therefore it is not necessary to form a cut-off on the EC mirror to detect the back side light. The mirror base has an enough room to include these sensors and therefore the mounting of the sensors and setting of harness can be facilitated. In addition the room of the mirror housing can be shared for other sensors, that is, it can be said that the total room of the outer mirror comprising a mirror base and a mirror housing can be effectively used.

The automatic anti-glare outer mirror is not necessary to be mounted to the both sides of the automobile but one side mounting is allowed. If two sets of the automatic anti-glare outer mirror are mounted both sides, outer mirrors that have independently characterized anti-glare effects can be used.

It is possible to install the control means in the mirror base in the automatic anti-glare outer mirror according to the present invention.

In such installation of the control means, the surrounding light sensor, the back side light sensor and the control means are all installed in the mirror base. Therefore mounting these components and setting the harnesses are easy and the exchange service from the conventional outer mirrors to the automatic anti-glare mirrors can be simply done since no such control means are set in the automobile.

The system of the automatic anti-glare outer mirror according to the present invention comprises plural EC mirrors of which reflectivities are adjusted by the EC film, surrounding light sensors, back side light sensors, control means that control the reflectivities of the EC mirrors using the sensor signals obtained by the surrounding light sensors and the back side light sensors and is composed in such a construction that these two light sensors are installed in a mirror base which composes an outer mirror and extends outward from the side of the automobile.

By such system construction, a pair of the surrounding light sensor, the back side light sensor and a control means can perform the anti-glare effect for a plurality of EC mirrors used for outer mirrors and inner mirrors. Therefore the system can reduce the quantities of necessary parts and the labors necessary for installation and cabling. The place to which the mirror base including the surrounding light sensor and the back side light sensor are installed can be the left (driver side) or right (passenger side) of the automobile.

The system of the automatic anti-glare outer mirror according to the present invention is applicable to the configuration that at least one of the EC mirrors is an inner mirror. In this case, it is not necessary to equip the inner mirror with the surrounding light sensor, the back side light sensor or the control means. Therefore it is possible to modify the outer design for the purpose of good appearance design fitting to the driver cabin and enhance the durability against the transportation vibration by the lightening the weight of the inner mirror.

By applying the present invention, it is possible to construct an automatic anti-glare outer mirror system such that the surrounding light sensor and the back side light sensor are installed in a place other than in the mirror housing. The mirror housing 20 is assembled in the following process. A lower housing 26 is put on to the sub-assembly 25 in tight fixing with the upper housing 22. The frame 21, the upper housing 22 and the lower housing 26 are made of high stiffness plastic.

### BRIEF DESCRIPTION OF THE DRAWINGS

FIG. 1 is a perspective drawing that shows the left side of the automobile having the outer mirror according to the first embodiment of the present invention FIG. 2 is an exploded perspective drawing that shows the construction of the outer mirror according to the present invention.

FIG. 3A is an exploded perspective drawing that shows the construction of the antenna unit fixing.

FIG. 3B is a drawing that shows an enlarged view of the antenna fixture.

FIG. 4A and FIG. 4B are a schematic that shows the embodiments of wiring between the antenna unit and on-vehicle device.

FIG. 5 is a schematic that shows a navigation system using the outer mirror according to the first embodiment of the present invention.

FIG. 6 is a perspective drawing that shows the outer mirror according to the second embodiment of the present invention.

FIG. 7 is a schematic that shows an automobile using the outer mirror according to the third embodiment of the present invention.

FIG. 8 is a perspective drawing that shows a modification of the mirror base of the present invention.

FIG. 9 is a perspective drawing that shows a conventional outer mirror.

FIG. 10 is a perspective drawing that shows another conventional outer mirror.

FIG. 11 is a perspective drawing that shows another conventional outer mirror.

FIG. 12 is a perspective drawing that shows an outer mirror according to the fourth embodiment in the present invention.

FIG. 13 is an exploded perspective drawing that shows a construction of an outer mirror.

FIG. 14 is a perspective drawing that shows an outer mirror to which a CCD camera is attached.

FIG. 15 is a perspective drawing that shows an automobile to which outer mirrors are installed.

FIG. 16 is a schematic shows a display that present a monitoring image taken by the CCD camera.

FIG. 17 is a schematic that shows range of monitoring by the CCD camera attached to an outer mirror.

FIG. 18 is a schematic that shows CCD attached to a salient.

FIG. 19A is a schematic that shows an installation of an automatic anti-glare outer mirror according to the fifth embodiment of the present invention.

FIG. 19B is a schematic that shows close up view of the automatic anti-glare outer mirror.

FIG. 20 is a cross sectional drawing that shows cut view of the fifth embodiment of the present invention.

FIG. 21 is a block diagram that shows the system of the automatic anti-glare out mirror according to the fifth embodiment of the present invention.

FIG. 22 is a block diagram that shows the system of the automatic anti-glare out mirror according to the sixth embodiment of the present invention.

FIG. 23 is a schematic that shows an example of the automatic anti-glare out mirror according to the past patent application (a substantial part of a Published Japanese Patent Applications: JP, 08-106110, A (1996)).

FIG. 24 is a perspective drawing that shows an outer mirror according to the seventh embodiment of the present invention.

FIG. 25 is an exploded perspective drawing that shows a composition of an outer mirror

FIG. 26 is a perspective drawing that shows the installation of a loud speaker in mirror base.

FIG. 27 is a schematic that shows the range of the audible sound from the loud speaker.

FIG. 28 is a perspective drawing that shows an example of using an outer mirror according to an embodiment of the present invention.

FIG. 29A is an exploded perspective drawing that shows a mirror base having two loud speakers.

FIG. 29B is an exploded perspective drawing that shows an installation of the mirrors on a rotating stage.

FIG. 30 is a perspective drawing that shows the outer mirror attached to an automobile according to the eighth embodiment of the present invention

FIG. 31 is an exploded perspective drawing that shows the outer mirror 401 shown in FIG. 30.

FIG. 32 is a schematic that shows the positional relation between a drive and a passenger who use a sub mirror.

FIG. 33 is a perspective drawing that shows the outer mirror 401 viewed from inside of an automobile.

FIG. 34 is a perspective drawing that shows an outer mirror having two sub mirrors horizontally aligned in a mirror base.

FIG. 35 is a perspective drawing that shows an outer mirror having two sub mirrors vertically aligned in a mirror base.

FIG. 36A is a perspective drawing that shows a sub mirror attachment before attaching.

FIG. 36B is a perspective drawing that shows a sub mirror attachment after attaching.

FIG. 37A is a perspective drawing that shows a sub mirror attachment in the first installation method

FIG. 37B is a cross sectional drawing that shows a cut view along the place A-A shown in FIG. 37A.

FIG. 38A is a perspective drawing that shows a sub mirror attachment in the second installation method

FIG. 38B is a cross sectional drawing that shows a cut view along the place B-B shown in FIG. 38A.

FIG. 39A is a perspective drawing that shows a sub mirror attachment in the third installation method.

FIG. 39B is a cross sectional drawing that shows a cut view along the line C-C shown in FIG. 39A.

FIG. 40A is a perspective drawing that shows a cover before the cover is attached.

FIG. 40B is a perspective drawing that shows a cover after the cover is attached.

### PREFWEEWS EMBODIMENT OF THE INVWNTION

The embodiments of the present invention will be explained in detail with referring the attached drawings. In the explanation, the same codes will be used for the same elements and same discussions will be repeated over the drawings and in the following discussion, respectively. The definition of the words “front”, “back”, “left”, “right”, “upper” and “lower” are determined by the nominal figure of the automobile.

The First Embodiment

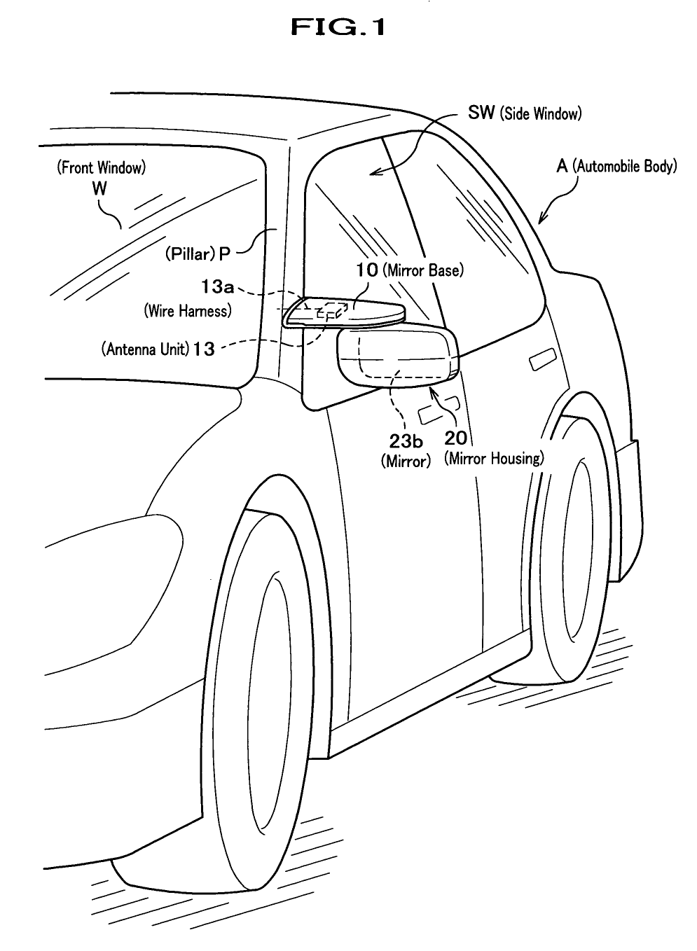

FIG. 1 shows a perspective view of the left front of the automobile to which the outer mirror according to the present invention is attached. FIG. 2 is an exploded view of the outer mirror. As shown in FIG. 1 and FIG. 2, the outer mirror of this embodiment has a mirror base 10 extending outward from the side of the automobile body A and a mirror housing 20 to which a mirror 23b is attached. The outer mirror is constructed in a form of “upper suspension”, where the mirror housing 20 is suspended by the mirror base 10 of its underneath and an antenna unit 13 is attached. In this embodiment, the mirror base 10 is fixed to the pillar P which is a frame work of the front window W and the mirror housing 20 rotates with an axis normal to the mirror base 10 so that the mirror housing 20 is set back to a housing position and resumed for operation.

In this embodiment, a pair of outer mirrors is fixed to the pillars of both side of the front window. The definition of “pillar” in this invention is not limited to the pillar formed on both sides of the front window but also the front portion of the frame of the side window.

Since the outer mirror according to the present embodiment has a mirror base 10 extending outward from the side of the automobile body A and the mirror housing is attached to the mirror base 10 of its underneath, the mirror base 10 is placed in the upper position against the mirror housing 20. The antenna unit 13 is attached to the mirror housing 10 and no mirror housing 20 is set or covers over the antenna unit 13 as seen in the conventional construction of the mirror housing. Therefore, the mirror hosing 20 does not impede against the radio wave transmission and receiving of the antenna and no obstruction of transmission and receiving of the radio wave is generated.

The function of each component will be explained in the following. As shown in FIG. 2, the mirror base 10 consists of a plastic base body 11 and a plastic cover 12 of which outer figures are formed into streamline shape. The inner room formed by the base body 11 and the cover 12 is enough to include the antenna unit 13, which is an embodiment of the present invention.

A multiple frequency band antenna that is in the bands of giga Hertz and applicable to GPS and ETC system is used for such an antenna unit 13 which has a flat shape. The configuration of two antenna units at both sides of the automobile body A construct a diversity antenna system. The larger signal received by one of these antennas than the other is selected to be connected. By this technology, the fading problem specific to the mobile receivers can be dissolved.

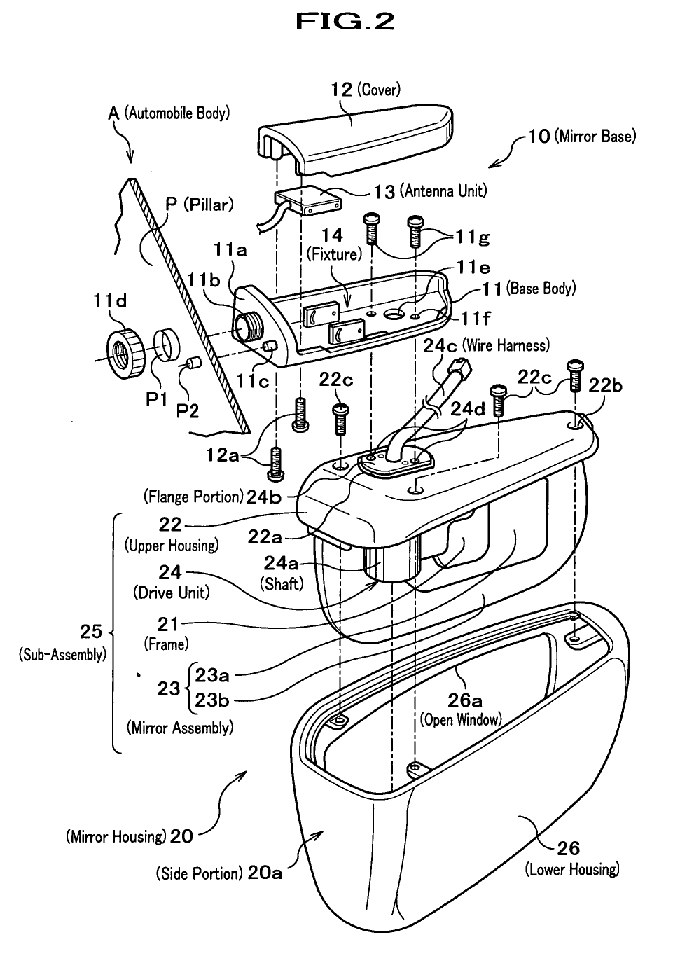

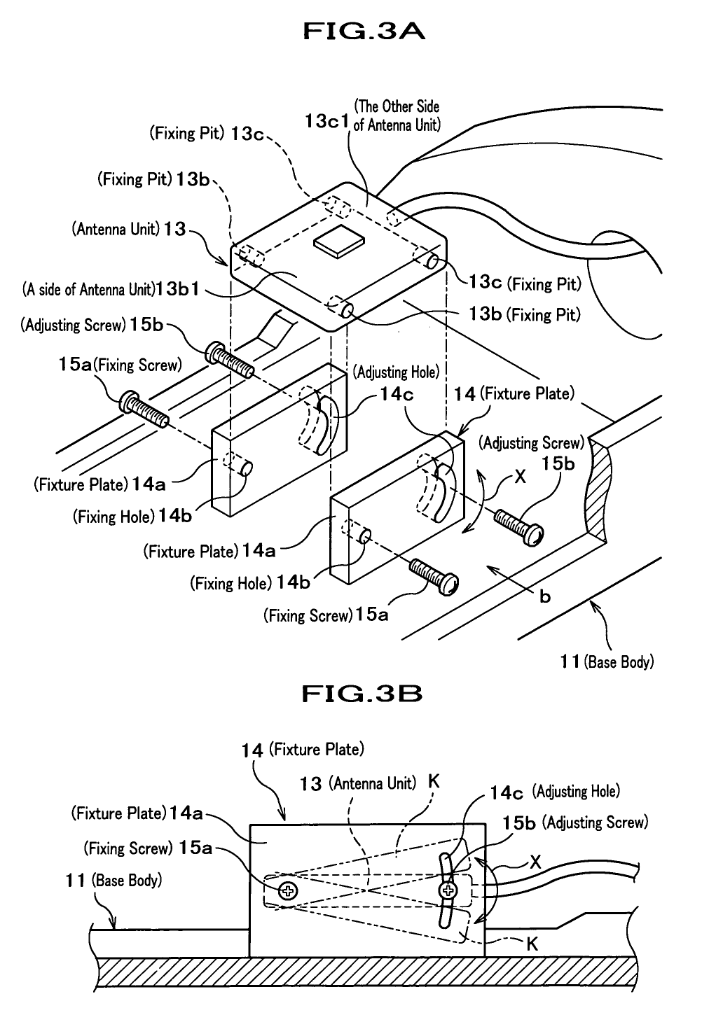

The antenna unit 13 is fixed to the base body 11 with a fixture 14 which serves for the directional adjustment of the antenna unit. As shown in FIG. 3A, the antenna unit 13 has fixing pits 13b and 13c at the side surfaces. The fixture 14 consists of two fixture plates 14a in which fixing holes 15a and adjusting holes 15b are formed. The antenna unit 13 is set between two fixture plates 14a and the fixing hole 14b, adjusting holes 14c of arc-shape for adjusting the antenna direction, fixing screws 15a and adjusting screws 15b are associated for fixing the antenna unit 13 which is fixed to the base body 11. The fixing process is carried out as follows. The antenna unit 13 is set between two fixture plates 14a. The fixing screws 15a are screwed in the fixing pits 13b formed in the antenna unit 13 through the fixing holes 14b formed in the fixture plate 14a. And a side (13b1) of the antenna 13 is held. Two adjusting screws 15b are inserted into adjusting holes 14c formed in the fixture plates 14a and are screwed into fixing pits 13c. Then the other side (13c1) of the antenna 13 is held. As the results, the antenna unit 13 is fixed to the fixture.

The antenna unit 13 can be rotated in a trace as shown by X in FIG. 3A by loosening the adjusting screws 15b and the rotational range is limited by movable range of the adjusting screw 15b along the adjusting hole 14c (the upper limit and the low limit of the movable range is shown by the code K and the two-dots-dashed lines in FIG. 3B). After adjusting the direction of the antenna unit 13 to have a preferable condition of the transmission and receiving of the radio wave, the adjusting screws 15b are firmly screwed and the direction of the antenna unit 13 is fixed with a mounting angle to maintain such direction. For example, when the antenna unit is used for and ETC antenna, it is desirable that the antenna unit 13 is held in an angle to have the optimum transmission and receiving of the radio wave in passing through the designated gates for traffics on a toll road.

In this embodiment, the antenna unit 13 is covered by a cover 12 so that the unexpected external force, such as a little children's touching and fumbling, is not applied to the antenna unit 13 and it is possible to keep the direction unchanged.

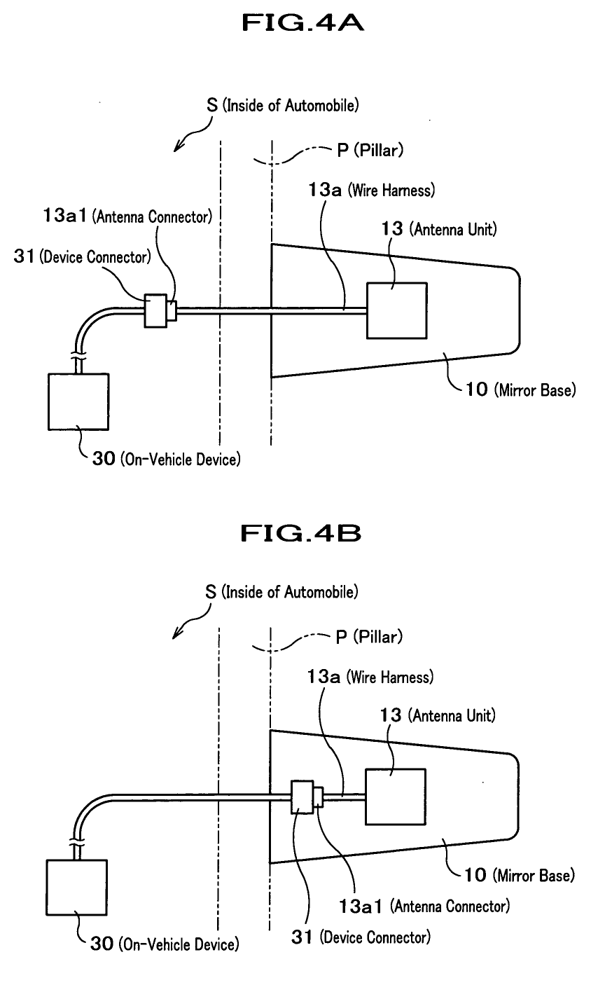

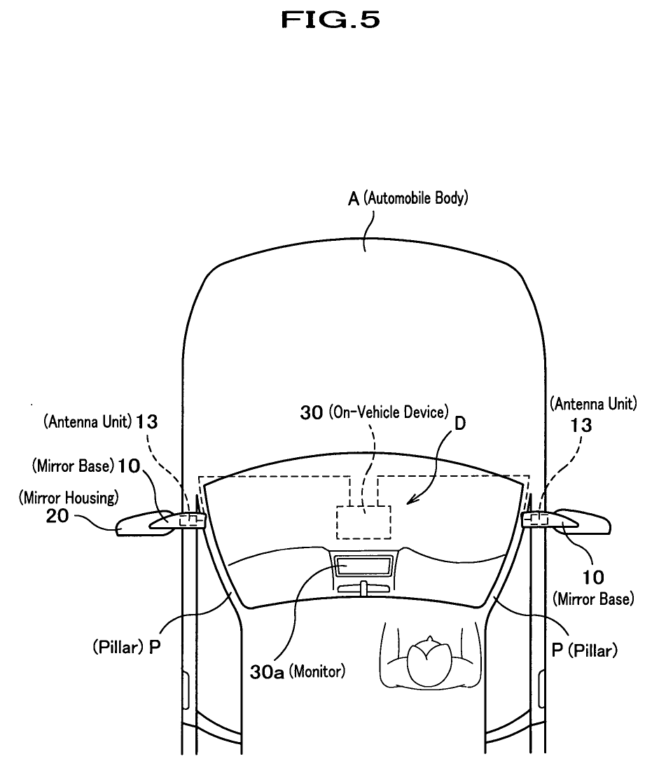

There are two implementations in mounting the antenna unit 13 with regard to the length of wire harness 13a as shown in FIG. 4A and FIG. 4B. That is, for a long wire harness 13a from the antenna unit 13 as shown in FIG. 4A, the antenna connector 13a1 is set in an inside of the automobile body wherein the wire harness is set in the mirror base 10, through the pillar P and in the automobile inside S. Then the antenna connecter 13a1 is electrically connected to the device connector 31 of the on-vehicle device 30. For a short wire harness 13a as shown in FIG. 4B, the wire harness is set in the mirror base 10 up to the connector 13a1 set in the mirror base, then another wire harness from the on-vehicle device 30 to the device connector 31 is set in the automobile inside S. For either case, it is simple to set the wire harness and easy to attach the antenna unit. Especially the implementation as shown in FIG. 4B provides the electrical connection done in the mirror base 10 so that it is possible to attach the antenna unit 13 after the assembly of the automobile and it is easy to exchange the antenna unit after completion of assembling. Therefore the grade up of the antenna or the antenna replacement for the purpose of system change is facilitated. For example, the antenna of mobile broadcasting wave as S-band (2.6 GHz) or that used for bilateral broadband service, that is roaming mobile phone and wireless communication system, can be mounted. For this case, two antenna units which are necessary for the mobile broadcasting are mounted in the two mirror bases placed at the right and left sides of the automobile. Therefore the distance between the antenna units is kept relatively long in the order of the wave length and the radio wave receiving with less interference is realized, that serves for preferable radio wave receiving.

As shown in FIG. 2, the cover 12 is set to the base body 11 with a gasket (which is not shown in FIG. 2) and fixed with two screws 12a. In this embodiment, the cover 12 is made of painted or colored plastic for the purpose no to see the inside that may serve for good external appearance. Since the cover is not made of a metallic material, the radio wave can reach to the antenna unit 13. The presence of the cover 12 over the base body 11 can keep the dust and water off in the mirror base 11. It is obvious that the cover 12 can be made of transparent or translucent plastics.

The mirror base as shown in FIG. 2 has a screw portion 11b formed in the terminal surface 11a of the base body 11 so that the mirror base 10 can be fixed to the pillar P by the following order of assembling as screw portion 11b is inserted into a holding hole P1, a salient 11c formed on the terminal surface 11a is inserted into a positioning hole P2 formed in the pillar P and a fixing nut lid is screwed into the screw portion 11b from the back side of the pillar P. In this assembly, the mirror base 10 can be extending outward from the side of the automobile. In addition, the mirror base 10 can be fixed to the pillar P by using an adhesive other than the screws as described above.

The mirror housing 20 is composed of a sub-assembly 25 and a lower housing 26. The sub-assembly 25 comprises a frame 21, an upper housing 22 attached to the frame 21, a mirror assembly 23 and the driving unit 24. The whole mirror housing 20 is completed with the sub-assembly 25 assembled with the lower housing 26 by setting and fixing the lower housing 26 onto the upper housing 22. The frame 21, the upper housing 22 and the lower housing 26 are made of a high rigid plastic such as an engineering plastic.

On the upper side of the upper housing 22, a hole 22a is opened into which a flange portion 24b linked to a shaft 24a working as a rotational shaft of the mirror housing 20 is set.

The mirror assembly 23 has a mirror 23b (the back side of the mirror is shown in FIG. 2) which is attached to an actuator 23a, being fixed to a frame 21, for adjusting the mirror angle wherein the normal direction of the mirror 23b is changeable in upper ward and lower ward by driving the actuator 23a.

The drive unit is equipped with a motor and a gear box. The slowed down rotation is transmitted to the shaft 24a. The wire harness 24c necessary for the actuator 23a is led out to the center of the flange portion 24b through the shaft 24b.

The lower housing 26 is set and fixed to the upper housing 22 of the sub-assembly 25 by three screws 22c. An open window 26a is formed in portion corresponding to the mirror 23b in the lower housing 26 so that the mirror 23b movably stays in the lower housing 26 once fixed to the upper housing 22.

The mirror housing 20 is fixed to the base body 11 of the mirror base 10 by setting the flange portion 24b onto the lower surface of the base body 11 and tightening the screws 11g in the holes 24d after the wire harness 24c is set through the hole 11e opened in the base body 11. The wire harness 24c is led to the pillar P through the contacting side 11a of the mirror base and the screw 11b and is electrically connected to another wire harness (not shown in the drawing) from the on-vehicle device by which the mirror housing 20 is set back to a housing position and resumed for operation. The change of the mirror directional angle can be carried out by a control unit (not shown in the figures) placed close to the driver seat.

Once the mirror housing 20 is set back to a housing position or reset forth to resume operation, the direction of the antenna unit is unchanged, which is different from the conventional installation of the antenna units which are set in the mirror housing. Therefore a stable transmitting and receiving radio waves is possible.

Since the antenna nit is mounted to the mirror base 10, the effect of the vibration and/or mechanical resonance is less than that in the case when the antenna unit is mounted to the mirror housing. Therefore a stable transmitting and receiving radio waves is possible.

The automobile using the outer mirror described above receives the radio signals from satellites (not shown in the figures) at the antenna units installed in the mirror bases 10 at the right and left sides of the automobile and the signal is detected by a car navigation system 30 set in the dash board D as one of on-vehicle device. The car navigation system 30 detects the radio signal received by the antenna units 13 and the global position information of the automobile is displayed on the monitor 30a. Since the antennas 13 are set in the mirror base 10 which is the upper portion of the upper suspension outer mirror and there is no material to shield the radio signal from the satellites onto the antenna units, a direct signal reception is possible that results in serving a strong signal receiving to the car navigation system 30. When the automobile runs through an ETC gate on a toll road, the antenna serves a reliable communication with the transceiver of the ETC system of which antenna locates upper position in comparison to the upper suspension outer mirrors wherein no material to shield the radio signal from the ETC system onto the antenna units 30 exists.

Moreover, the direction of the antenna units 13 can be adjusted by the fixtures 14 (see FIG. 3A and 3B) to receive the radio signal in the optimum condition and good quality communication is possible. It is possible to use various kinds of antenna units since the antenna units can be easily exchanged after assembling and adjusted to be compliant to the antenna characteristics.

The automobile can transmit and receive the radio wave through the antenna unit 13 installed in right and left sides of the automobile. Therefore, eve if one of the antenna units cannot be used or out of service due to troubles or traffic accidents, the other antenna unit 13 can be served for the communication so that the emergency communication can be supported by the system of this outer mirror. By this features of the system, the present invention serves for an emergent position information report such as help net etc. Since the antenna unit 13 is a complex antenna unit and can receive radio waves of a plural frequency bands, a single antenna unit can support plural on-vehicle devices. It is possible to attach different antenna units for right and left sides of the automobile and therefore the plural on-vehicle devices can be in service due to the versatility of application in the usage.

Second Embodiment

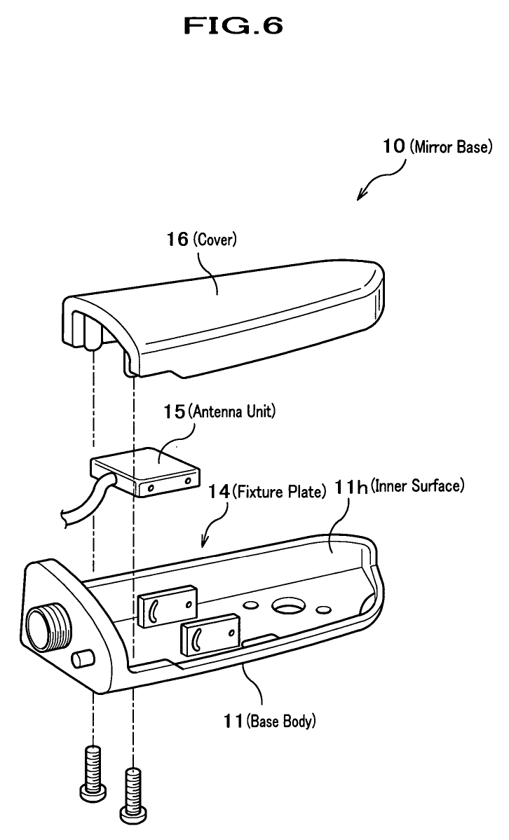

FIG. 6 shows a perspective view of a mirror base of an outer mirror according to the second embodiment of the present invention. The difference of this outer mirror from the outer mirror according to the first embodiment is that an antenna unit 15 for VICS is set in the mirror base 10.

The antenna unit 15 set in the mirror base 10 has sensitivity even for infrared light and the cover 16 over the antenna 15 is made of a plastic material that can be transmittable for the infrared light. The cover 16 may be coated to have preferable transmission efficiency. The base body 11 of the mirror base 10 has an inner surface that is frost-painted with black color for the purpose of anti-reflection inside the hollow space of the mirror base.

By using this outer mirror, the cooperation under a linkage with a navigation system is possible as to collect the information of traffic news, optimum route guide and road map towards destinations and parks and the assisting information or auxiliary information to confirm the present positions and road names under driving by the signal of beacon radar, being set aside the highway, which are detected by means of the antenna unit 15 and the FM multiple data radio (which is built-in FM radio service) and detected by means of a combination of the antenna unit 15 and such FM data receiver.

Since the inside of the base body 11 is frost-painted, therefore the infrared scattering in the hollow of the mirror base is suppressed and the infrared signal detection is not disturbed by such scattering, that results in a preferable signal receiving.

Third Embodiment

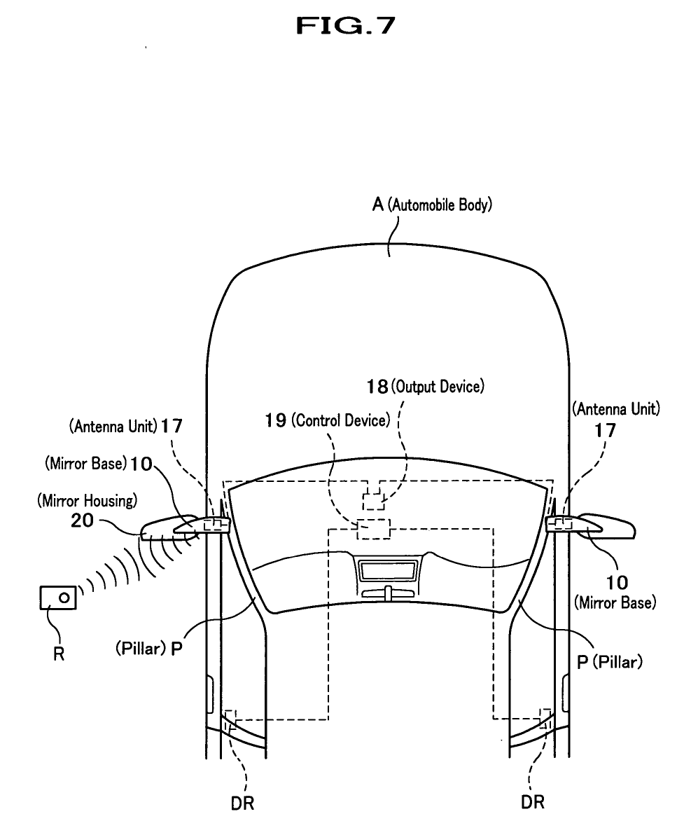

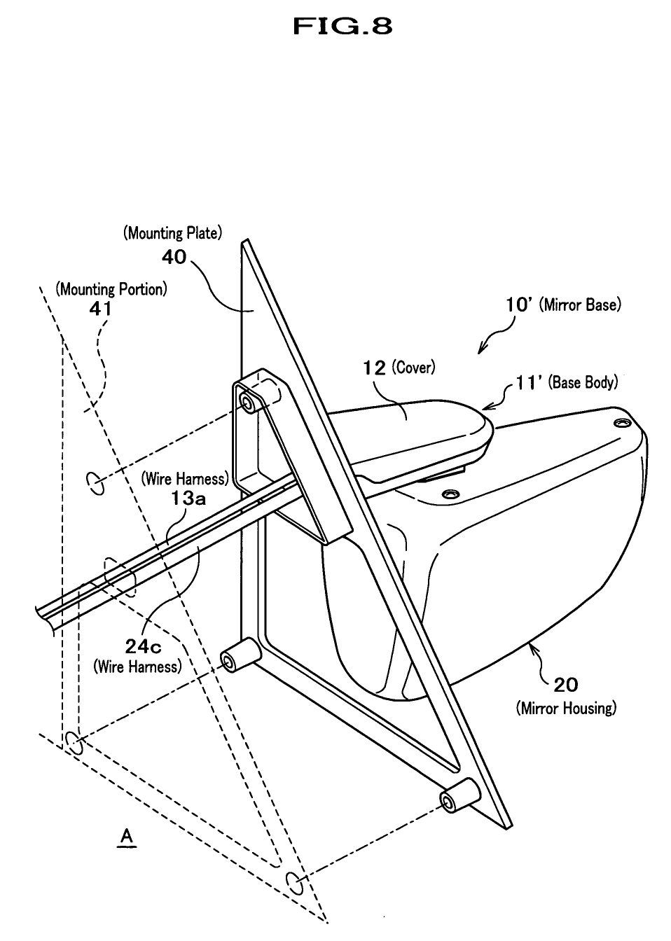

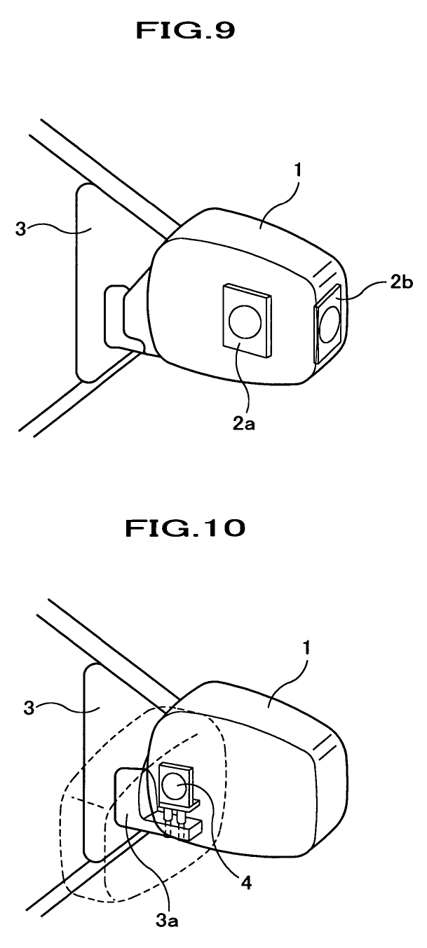

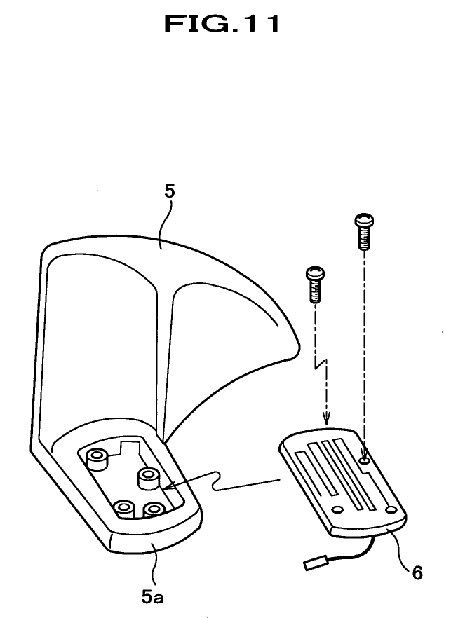

FIG. 7 is a schematic drawing that shows the automobile equipped with the outer mirror according to the third embodiment. In this embodiment, an antenna 17 for the application of so-called “smart key-less entry” (one of remote operation system; an automatic door lock/unlock operation for the person who carries a transmitting controller with him/her for the action to be close to or apart from the door) is installed in the mirror base 10.

This system comprises an antenna unit 17, an output device 18 and a control device 19 and a transmitting controller R. A radio signal (for example, 125 KHz) is transmitted through the antenna 17 by the output device 18. An electromagnetic field of the radio frequency is induced around the outer mirrors set both sides of the automobile.

Once the transmitting controller R receives a request signal at either antenna unit 17 in such an induced field, then the output device sends ID code in a radio wave transmitted through the antenna unit 17. The control device 19 receives the ID codes sent from the transmitting controller R through the antenna unit 17, check the code with a reference list of registered codes and executes the door lock/unlock by controlling the door lock device DR once correspondence of the ID code to the registered code is found by the controller. For example, the antenna unit 17 at the left side of the automobile detects the radio wave, then the door lock/unlock is executed by the left door lock device DR which is controlled by the control device 19.

The automobile which uses this output mirrors locks or unlocks the door to which the person (not shown in the figures) who holds the transmitting controller R. More specifically, the door is unlocked only when he comes closer to the door and is locked only when he leaves apart from the automobile.

The outer mirrors explained in all previous embodiments are electrically driven to be set back to a housing position, however it is not necessary that the outer mirror of the present invention is not confined in such a mechanical system but the present invention is applicable to a hand setting system or non-housing (fixed) system of the outer mirror.

All embodiments explained above have mirror bases 10 that are installed onto the pillar P, however the mechanical system is not limited in this installation but the mirror bases 10 can be the front triangles of the side windows, the partitioning frames between the forward side window and backward side window or be direct to the glass surface of the side window.

The mirror base 10 consists of the base body 11 and the cover 12 however the mechanical system is not limited in this construction. For example, the base body 11′ can be assembled with a fitting plate 40 which is fitted to the front triangle corner of the side window in order to integrate into a single component such as the mirror base 10′ as shown in FIG. 8. The outer mirror is fixed to the automobile body A when the fitting plate 40 is fixed to the front triangle of the side window at the fitting portion formed therein.

In the above embodiments, antenna units 13, 15 and 17 are set in the mirror base 10, however it can be set on top of the cover 12 and 16 exposing in upward direction. In order to prevent the damage from scratches against and dirt on the antenna unit 13, 15 and 17, it is preferable that the surface is processed to be covered hardened by a protective coating film.

Fourth Embodiment

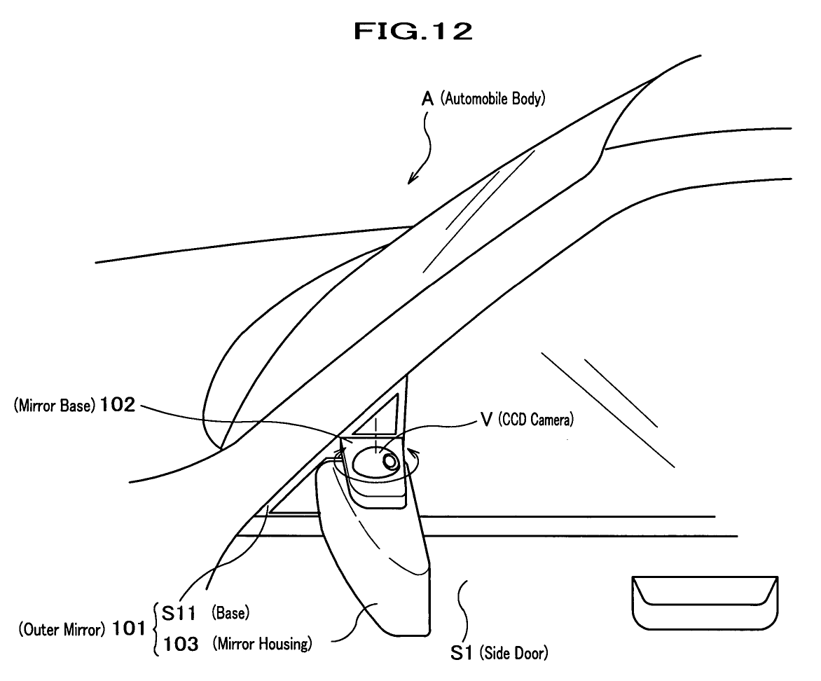

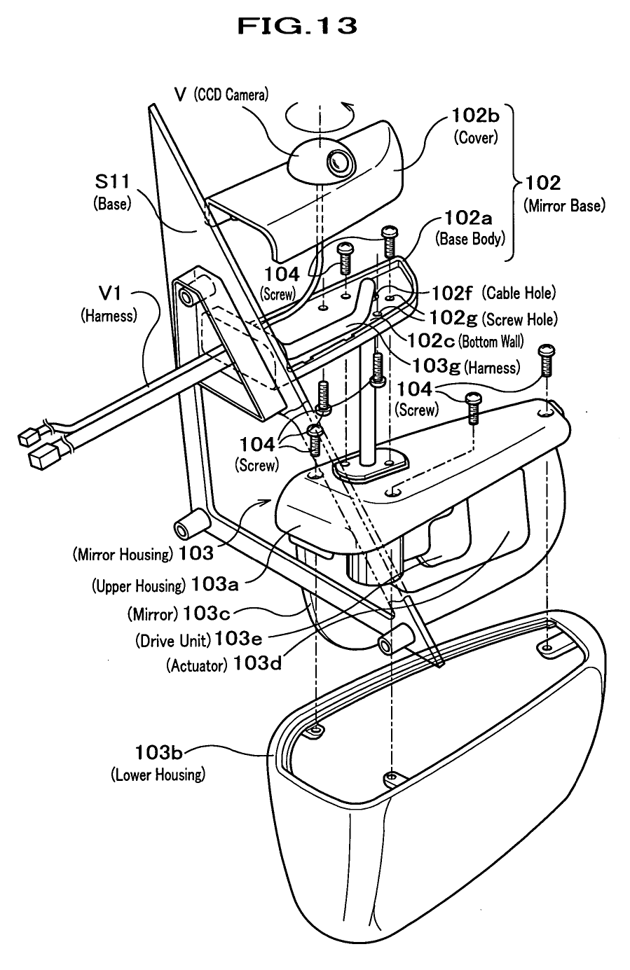

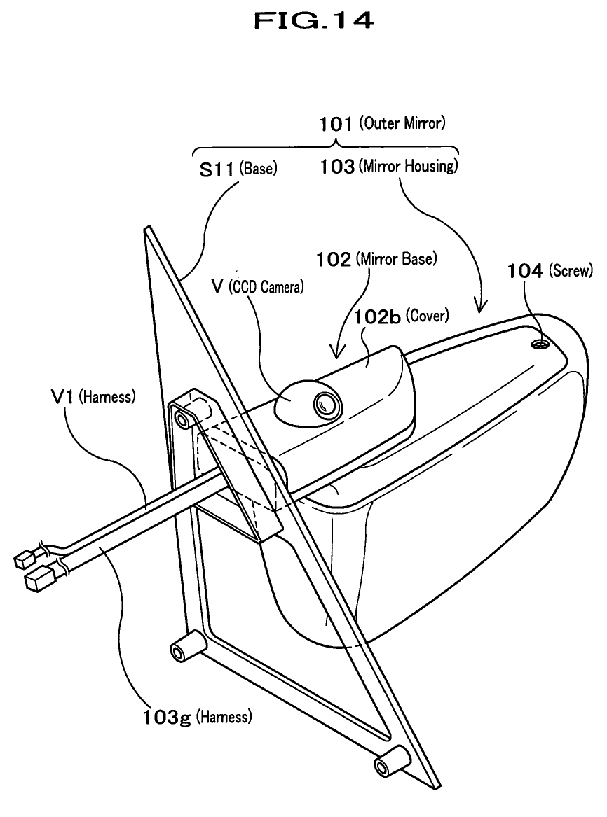

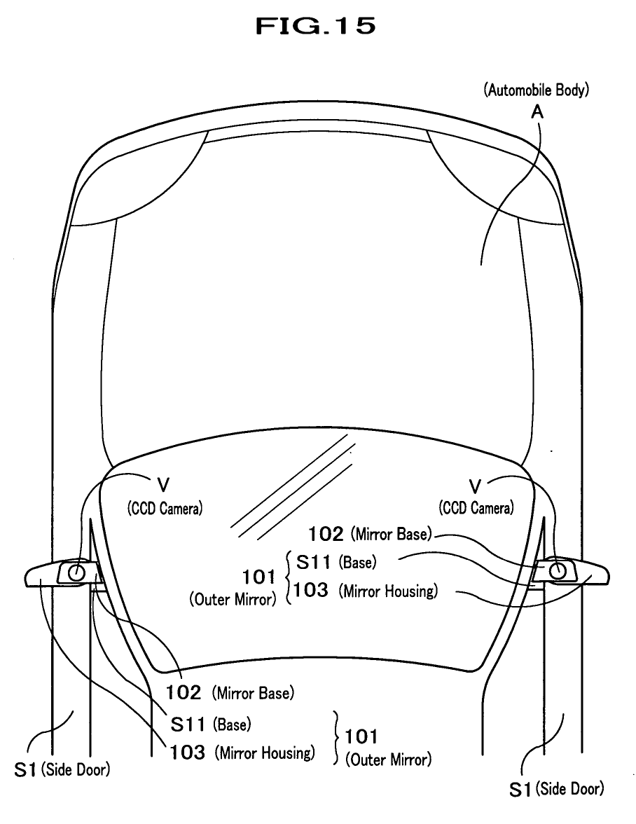

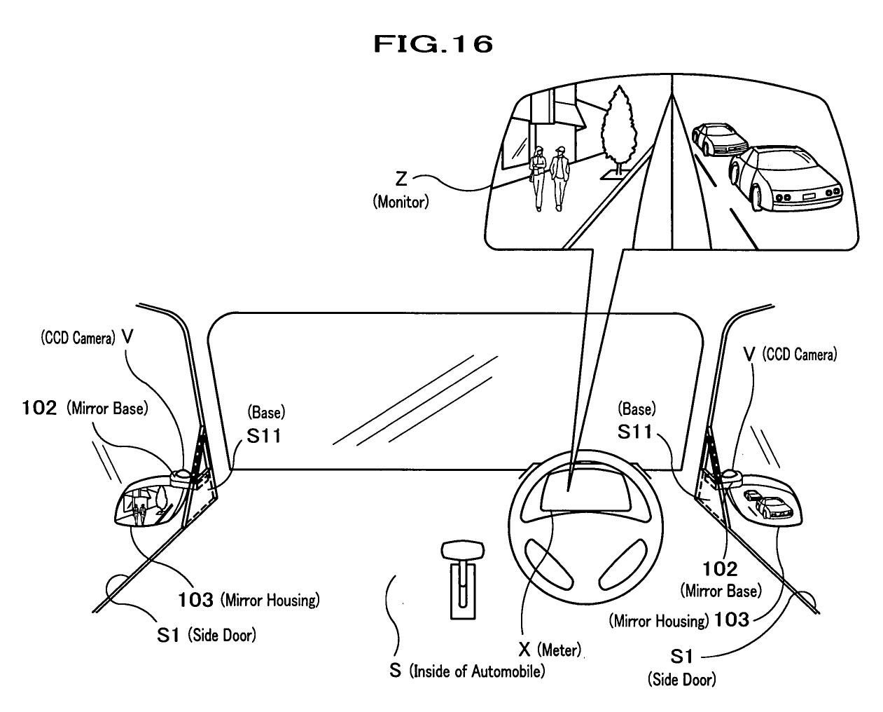

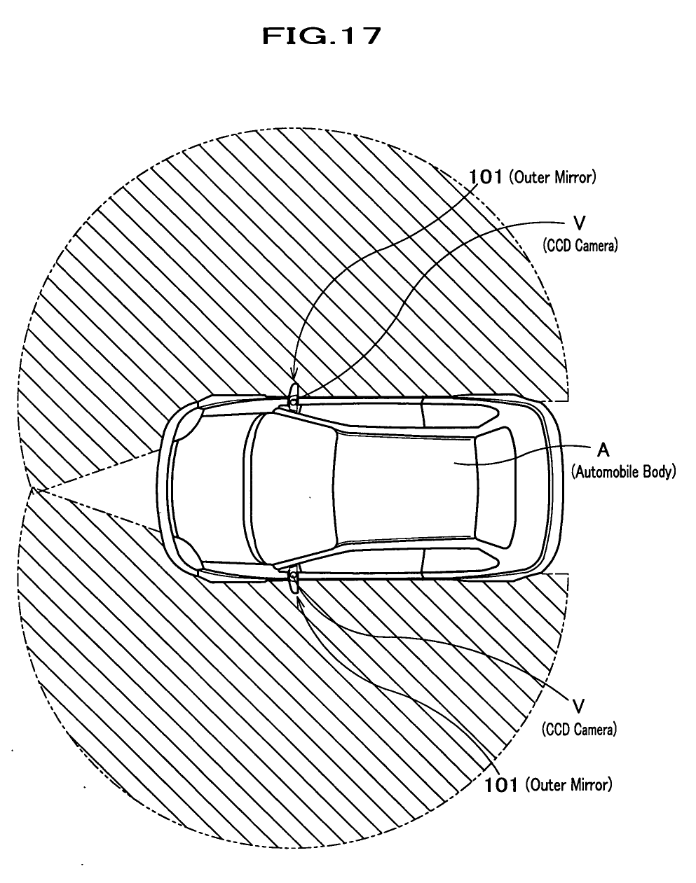

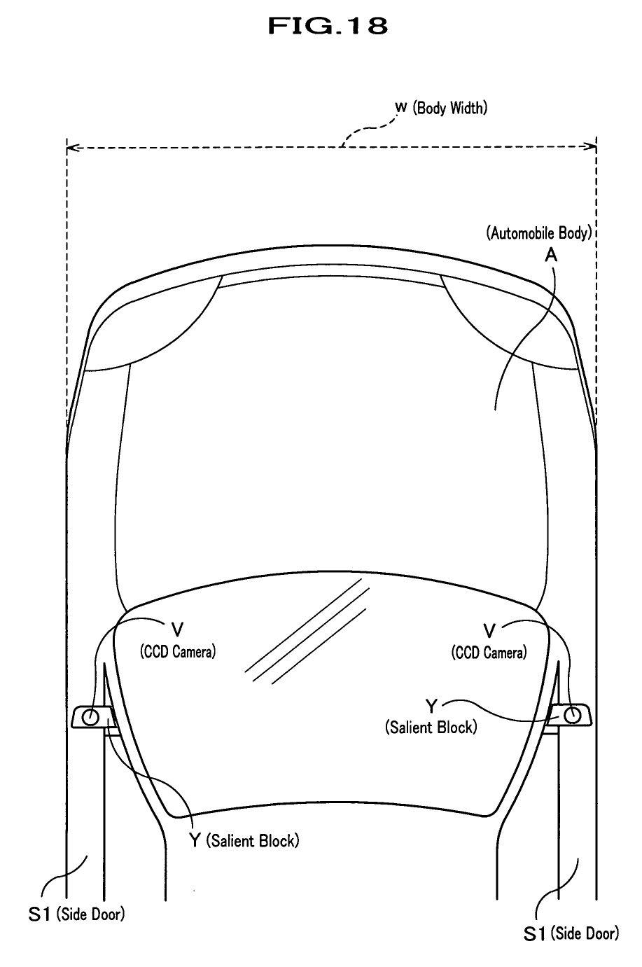

A surrounding area monitoring device according to another embodiment of the present invention will be explained with schematic drawings as follows. FIG. 12 shows a perspective drawing of an outer mirror according to an embodiment. FIG. 13 is an exploded view of the outer mirror construction. FIG. 14 is a perspective drawing of the outer mirror to which a CCD camera is attached. FIG. 15 shows the system construction of the outer mirror assembled in the automobile. FIG. 16 shows an implementation of the monitor working with the CCD camera. FIG. 17 shows the range of the monitoring scope by using the CCD camera installed in the outer mirror. FIG. 18 shows the installation of CCD cameras in salient block.

The outer mirror according to this embodiment is a door mirror attached to the side door S1 of an automobile body A. The outer mirror comprises a base S11 integrated with a mirror base 102 (a salient bock) extending outward from the side surface of the side door S1 and a mirror housing 103 suspended underneath the mirror housing 103 (see FIG. 13). The outer mirror 101 of the present embodiment is electrically driven to be set back to a housing position and the mirror housing 103 is suspended underneath the mirror base 102 with a rotational flexibility.

The base S11 is made of a plastic and formed into an integrated component with a mirror base 102 (a salient bock) extending outward. As shown in FIG. 12 and FIG. 13, the base S11 is fixed to the front portion of the side door S1. The mirror base 102 consists of a base body 102a which is opened upward and a cover 102b that covers the open portion of the base body 102a.

The base body 102a consists of a bottom surface 102c and the upward standing surface around the peripheral of the bottom surface 102c. A cable hole 102f and screw hole 102g are formed in the bottom surface 102c.

A CCD camera V (an image taking means) is set on the top surface of the cover 102b with a rotational flexibility. The wire harness V1 extending from the CCD camera V is let to the inside of the automobile body.

The cover 102c is fixed to the base body 102a with screws 104. The CCD camera can be rotated by a motor or another rotation means and can be arbitrarily oriented to the object of which image the driver desires to take.

As shown in FIG. 13, the mirror housing 103 is composed of the upper housing 103a and the lower housing 103b which are made of plastic material. The upper housing 103a comprises a mirror 103c for safety check of the backward, oblique-backward and oblique-forward directions, an actuator 103d to adjust the direction of the mirror 103c in upward, downward, leftward or rightward and a drive unit 103e to set the mirror housing 103 back to the automobile. The wire harness 103g that supplies the electrical power to the actuator 103d and the drive unit 103e is installed in the automobile and connected to a connector used for a necessary device for controlling them. The upper housing 103a and the lower housing 103b are assembled with screws 104.

By assembling all components composing the outer mirror 101, an upper suspension outer mirror 101 featuring to have a CCD camera V is equipped on the top surface of the mirror base 102 and the mirror housing is suspended under the mirror base 102 with a rotational flexibility.

An assembly (see FIG. 14) of the outer mirror 101 as explained above can take the image of the surroundings in the side of the automobile by rotating the CCD camera V equipped on the mirror base 102 once it is installed to the side doors S1 close to the driver seat and the passenger seat. As the result, the upper scene is easily viewed since the CCD camera is equipped on the top surface of the mirror base 102 that assists the driver to surely check the traffic signals signs even when the automobile is running after a large trailer or a large truck.

The image taken by the CCD camera V which is installed to the side door S1 of the automobile is displayed on the monitor Z set in the place close to meters X at the front side board at the driver seat in the cabin S. Then, the driver can check the backward and the oblique-back direction without changing his or her sight direction in large angle.

The sight scope to be checked by the CCD camera is not only for the backward or oblique-backward but other directions by rotating the CCD camera V as shown in FIG. 17.

By keeping the mirror base 102 in the width of the automobile, it is possible to check the surroundings and surrounding areas by CCD camera even setting the outer mirror back to the automobile.

As shown in FIG. 18, a salient block Y formed at the same position as the outer mirror 101 on the side of the side door within the maximum width of an automobile can alternate the outer mirror 1001 by installing a CCD camera V in the salient block Y and displaying the image taken by the CCD camera V on the monitor Z set in the place close to meters X at the front side board at the driver seat in the cabin S. Then, the driver can surely check the backward and the oblique-back direction (see FIG. 16). By applying this implementation using the salient block Y to which a CCD camera V is installed, a new design different from that based on the mirror base becomes feasible. The mirror base 102 is exploited for this salient.

As discussed above, the embodiments of an surrounding area monitoring device according to the present invention have been explained, the present invention is applied to various modifications for these embodiments as far as the arts are confined within those involved in the scope of the claims.

For example, the above embodiments implement the CCD cameras set on the top surface of the mirror base 102, however, these cameras can be set under the outer surface of the mirror 102 by which the same effects as in the above embodiments can be obtained.

In addition, the present outer mirror can be integrated with an on-vehicle security system so that the present invention may be widely used. In this application of the present invention, the CCD camera V takes the image in the viewing range when the security system detects the unusualness in the monitored scopes and scenes. Then the image is sent to a security management center where the security manager checks the image and notifies the driver of the risk or danger by sending a signal for sounding a horn. The image taken by the CCD camera can be, if necessary, stored in a recording means which the on-vehicle security system is equipped with. The recording means can be whichever analogue or digital recording device as far as the images taken by the CCD camera V is recorded therein.

The present outer mirror can be used as night viewing monitoring by attaching an infrared camera to the mirror base 2 in addition to the CCD camera so that the image in the night with no surrounding light can be taken.

In stead of rotating the CCD camera V to have wide view of surroundings, a camera that has s wide view lens system, such as a fish-eye lens can serve a similar monitoring capability. The wide view facilitates the monitoring of inside of the cabin. Therefore, the invention can be useful for the preventive security against crime.

For obtaining wide view, another embodiment is possible, wherein plural CCD cameras directing different directions are attached to the mirror base 102.

Another embodiment wherein the mirror housing 103 is mounted on the mirror base 102 has the same effect with the embodiments explained above.

The construction of the mirror hosing is not limited to those explained above as far as it has the capability to install the mirror and the protective function of the components involved therein against the outside environment.

An automatic anti-glare outer mirror according to another embodiment of the present invention will be explained in the following. To begin with, the definitions of the back side light and the surrounding light are explained as; the back side lights are light beam emitted from the head lamps of the automobiles running after and the surrounding lights are the lights reaching to the automobile other than the back side lights. When the back side lights are more intense than the surrounding lights, the drivers feel the outer mirror glaring and anti-glaring effect is necessary for the outer mirror. In the following embodiments, the discussions are on the assumption that the surrounding lights are those from the front area for the purpose of simplicity.

Fifth Embodiment

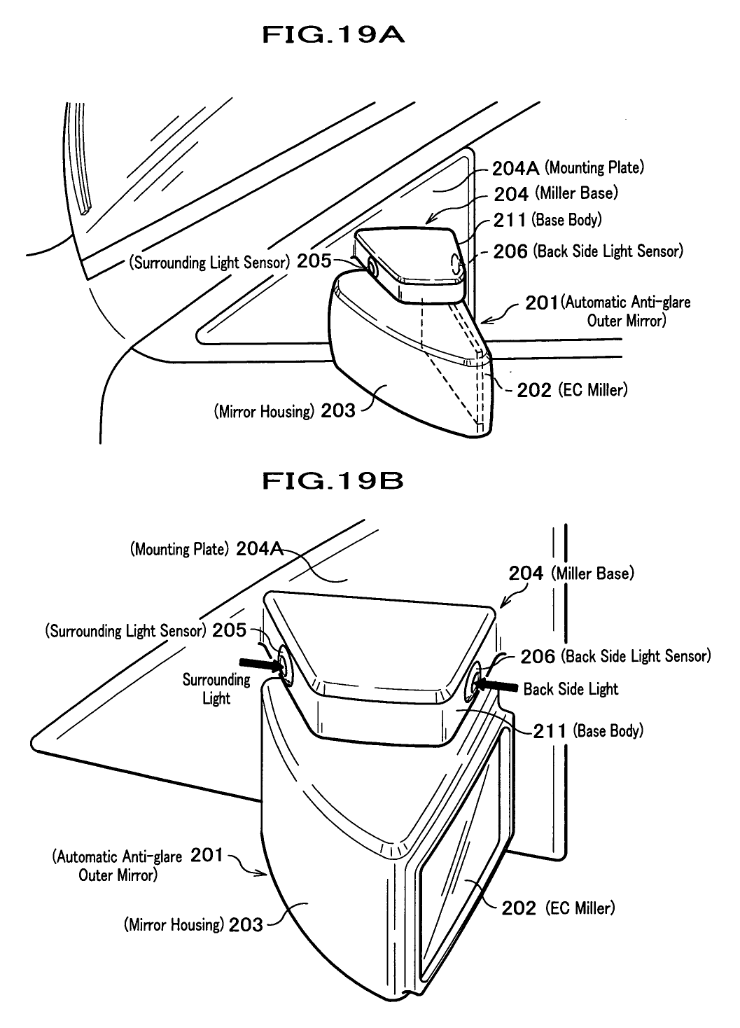

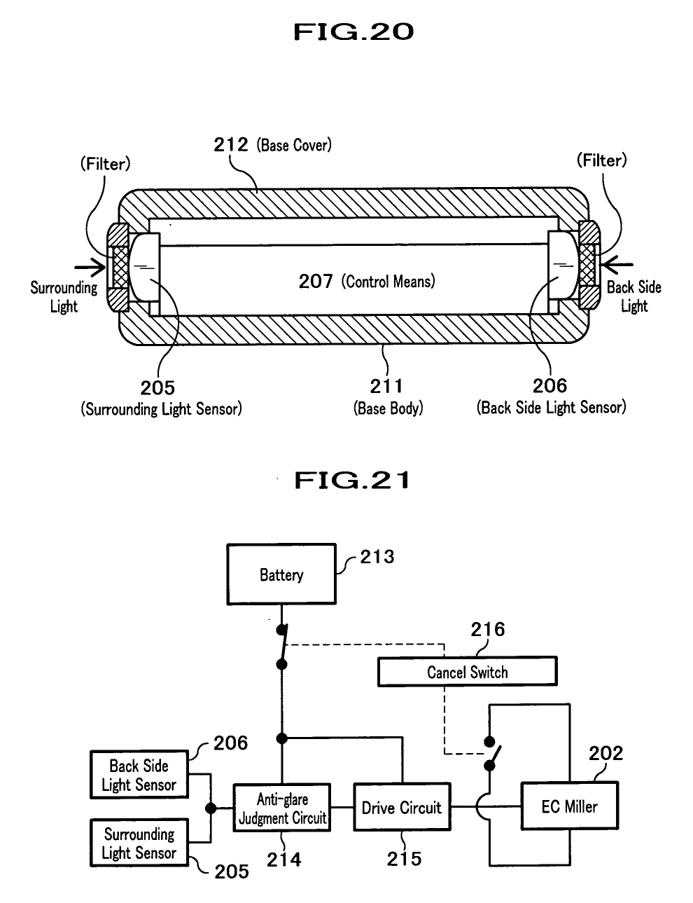

FIG. 19 shows a schematic of an automatic anti-glare outer mirror according to the fifth embodiment. FIG. 19A shows a setup of the automatic anti-glare outer mirror and FIG. 19B shows another view of the setup from a different view angle. FIG. 20 show a cross sectional view of the mirror base of the automatic anti-glare outer mirror according to the fifth embodiment. FIG. 21 is a block diagram of the circuit used for the automatic anti-glare outer mirror according to the fifth embodiment.

The construction of the automatic anti-glare outer mirror 201 is explained. As shown in FIG. 19, the automatic anti-glare outer mirror comprises a mirror base 204 extending outward from the side of the automobile body, EC mirror 202 of which reflectivity is variable by the coloring of the EC film and a mirror housing 203 suspended under mirror base 204 with rotation flexibility. The mirror base 204 is set at the triangle corner portion of the front lower part of the side window and consists of a mounting plate 204A of substantially triangle shape attached on the triangle corner and a base body 211 extending from the mounting plate 204A.

As shown in FIG. 20, the base body 211 opens on the top to which a base cover is attached and includes a surrounding light sensor 205, a back side light sensor 206 and a control means 207. The surrounding light sensor 205 is set at the front of the mirror base 204 in a forward direction and the back side light sensor 206 is set at the tail of the mirror base in a backward direction. The surrounding light sensor 205 and the back side light sensor 206 have filters on the sensor front for the purpose of preventing dirt attaching on the sensor front surface by rain drops and exhaust gases.

As shown in FIG. 21, the control means 207 comprises an anti-glare judgment circuit and a drive circuit 215. A battery 213 supplies power to the anti-glare circuit 214, the drive circuit 215 and CE mirror 202. A cancel switch 216 is installed in the cabin.

The operation of the automatic anti-glare outer mirror 201 will be explained.

The surrounding light sensor 205 and the back side light sensor 206 detect the surrounding lights and the back side lights. The signals of the detected surrounding lights and the detected back side lights are sent to the anti-glare judgment circuit 214. The necessity of the anti-glare function or the degree of the anti-glare is judged on the basis of the signal. For example, the difference between the intensity of the back side lights and the intensity of the surrounding lights is computed and it is judged that the more the difference is the more necessary the effect of anti-glare is. The judgment result is sent to the drive circuit 215. The drive circuit 215 controls the power supply to the EC mirror 202 and changes the color (that is to change the reflectivity of the EC mirror) and activates the anti-glare effect. The power necessary for the anti-glare judgment circuit 214, drive circuit 215 and EC mirror 202 is supplied by the battery 213 installed in the automobile. There is a cancel switch 216 in the cabin and the driver can switch off this cancel switch and can shut off the power supply to the anti-glare circuit 21, the drive circuit 215 and the EC mirror 202.

As explained above, since the surrounding light sensor 205 and the back side light sensor 206 are mounted on the mirror base 204, the light detection can be done regardless to the direction of the mirror housing. It is not necessary to make a cut off in the EC mirror 202 to detect the light. It is easy to attach the surrounding light sensor and the back side light sensor and set the harness. There is a room left in the mirror housing and it can be used for other purposes. Since the mirror base has a construction such that the control means is installed therein, it is easy to install the control means afterwards.

In the fifth embodiment, the automatic anti-glare outer mirror 201 may be set in both sides of the automobile body or an either side. When the automatic anti-glare outer mirrors are set in the both sides, it is possible that these two outer mirrors have independently controllable anti-glare effects.

Sixth Embodiment

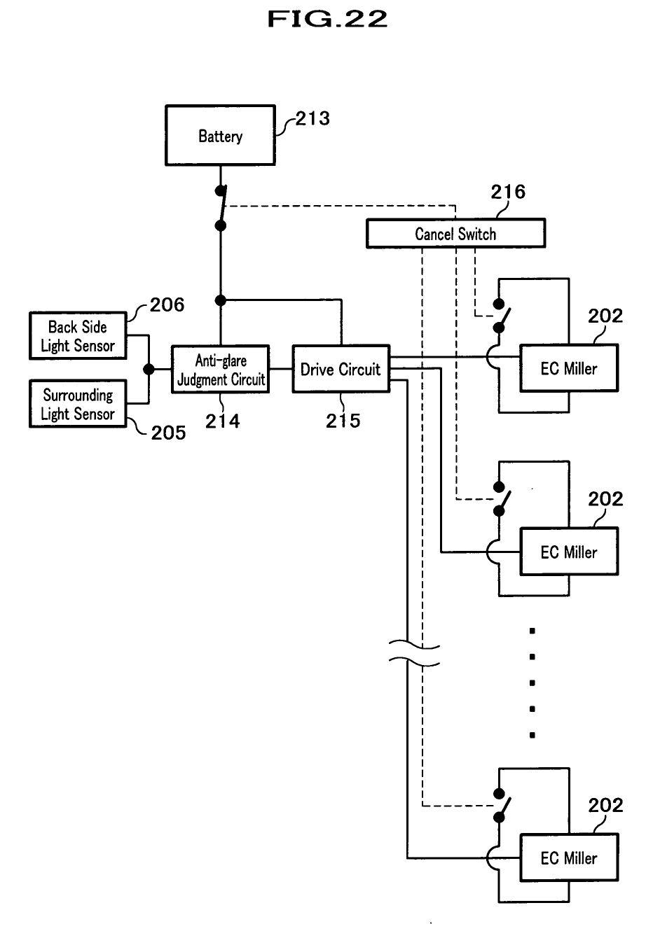

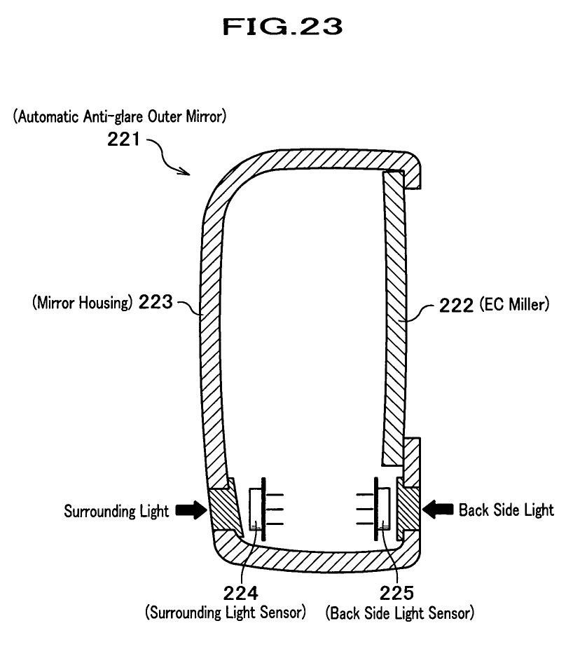

An anti-glare mirror according to the sixth embodiment will be explained. FIG. 22 shows a block diagram of the control system of the automatic anti-glare system according to the sixth embodiment.

To begin with, the control system is explained. As shown in FIG. 22, the surrounding light sensor 205, the back side light sensor 206, the judgment circuit 214 and the drive circuit 215 are installed in the mirror base of a single outer mirror (referring to FIG. 19 and FIG. 20). The composition of a plurality of mirrors as n-pieces is applied to the outer mirrors and the inner mirrors. For example, this system can be applicable to a pair of outer mirrors or the system that has a pair of outer mirrors and an inner mirror. The battery supplies the power to the anti-glare judgment circuit 214, the drive circuit 215 and n-pieces EC mirrors 202. A cancel switch is installed in the cabin.

The operation of the automatic anti-glare system is explained as follows. The surrounding light sensor 205 and the back side light sensor 206 detect the surrounding lights and the back side lights. The signals of the detected surrounding lights and the detected back side lights are sent to the anti-glare judgment circuit 214. The necessity of the anti-glare function or the degree of the anti-glare is judged on the basis of these signals. For example, the difference between the intensity of the back side lights and the intensity of the surrounding lights is computed and it is judged that the more the difference is the more necessary the effect of anti-glare is. The judgment result is sent to the drive circuit 215. The drive circuit 215 controls the power supply to n-pieces of EC mirror 202 and changes the color (that is to change the reflectivity of the EC mirror) and activates the anti-glare effect. The power necessary for the anti-glare judgment circuit 214, drive circuit 215 and EC mirror 202 is supplied by the battery 213 installed in the automobile. There is a cancel switch 216 in the cabin and the driver can switch off this cancel switch and can shut off the power supply to the anti-glare circuit 21, the drive circuit 215 and the EC mirror 202.

As explained above, the anti-glare effects of n-pieces of EC mirror 202 (the outer mirror and the inner mirror) are activated by only a pair of surrounding light sensor 205, the back side sensor 206 and the control means. It is possible to complete the system with a little number of the components and the assembly work with reduced number of processes.

In this automatic anti-glare system in the sixth embodiment of the outer mirror, a construction may be possible so that at least one of the EC mirrors is an inner mirror. In this case it is possible for the inner mirror to have an automatic anti-glare effect without having the surrounding light sensor, the back side light sensor and the control means installed in the inner mirror system by using the system of outer mirror. Therefore it is possible to modify the outer design for the purpose of good appearance design matching with the driver cabin and enhance the durability against the transportation vibration by the lightening the weight of the inner mirror.

In the sixth embodiment, the mirror base to which the surrounding light sensor 205 and the back side light sensor 206 are installed can be attached the left hand side (the driver sitting side) or the right hand side (the driver sitting side). In the embodiment explained above, a cancel switch 216 is installed to switch off all n-pieces EC mirrors at one switch-off action, however plural switches to switch-off each EC mirror can be associated with this embodiment.

It is possible to modify the construction and configuration of the system in the range of not changing the subject mater of the present invention. For example, an upper suspension outer mirror construction wherein the mirror housing is hanged underneath the mirror base is adopted for the fifth embodiment. However the construction is not limited into this construction as far as the surrounding light sensor and the back side light sensor are installed in the mirror base, but a construction such that the mirror housing is set on the mirror base is allowed.

The mirror base 204 can be formed into a shape such that the base body is directly mounted on to the side of the automobile without using the mounting plate 204a. The portion to which the base 204 is mounted can be a pillar by the front window of the automobile or a vertical frame that segregates the side window into the front part and the tail part.

The installation place of the control means 207 can be inside of the automobile other than the mirror base 204. The control method of the color control of the EC mirrors can be widely adopted as far as the anti-glare effect can be preferably functioned. The power supply that drives the EC mirror may be the battery installed in the automobile or the primary battery installed in the mirror base 204. By forming an opening portion in the mirror base, the primary battery can be easily exchanged.

In the above embodiments, the surrounding light sensor is set in the front portion to detect the light coming from the forward side. However as far as the surrounding light sensor properly detect the surrounding lights, the setting position is not limited as that described above. For instance, the surrounding light sensor is set upward in a vertical line or outward in a horizontal line.

The implementation of mounting the surrounding light sensors and the back side light sensors can be modified. For instance, the light sensors are installed in the mirror base, attached on the outer surface of the mirror base or the mountable/dismountable construction.

Seventh Embodiment

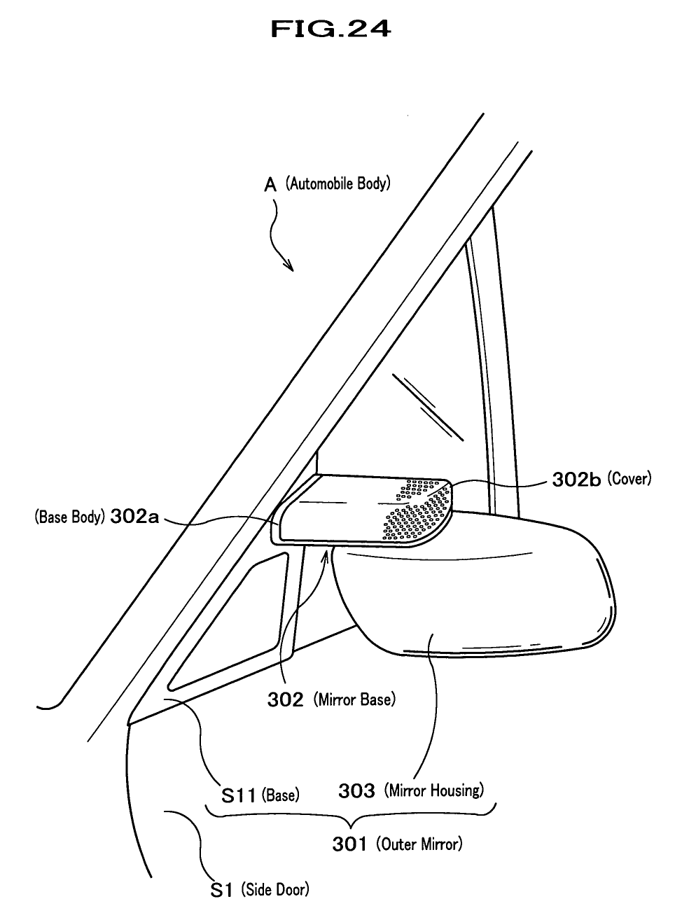

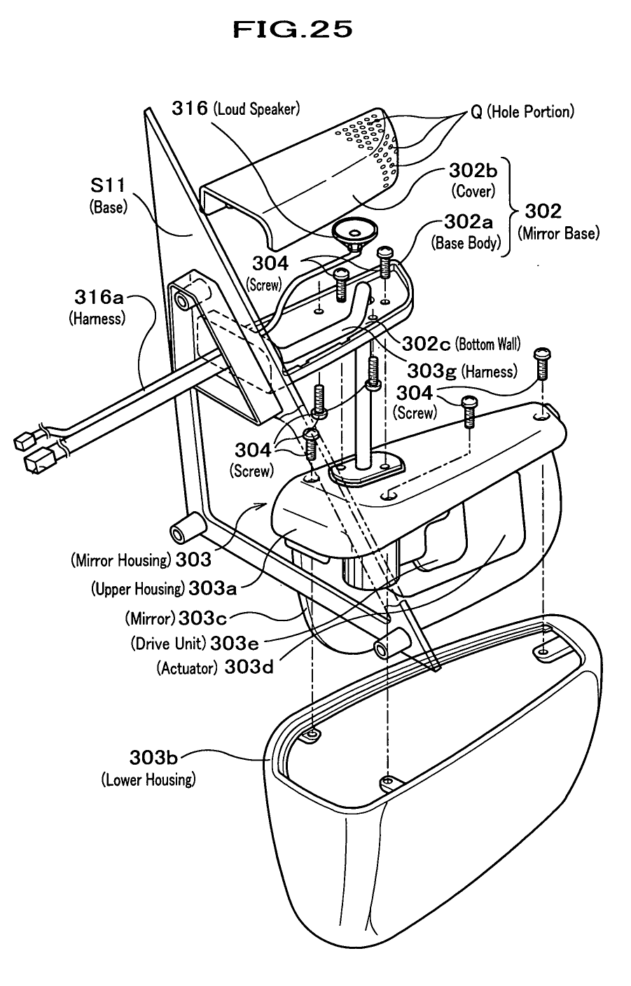

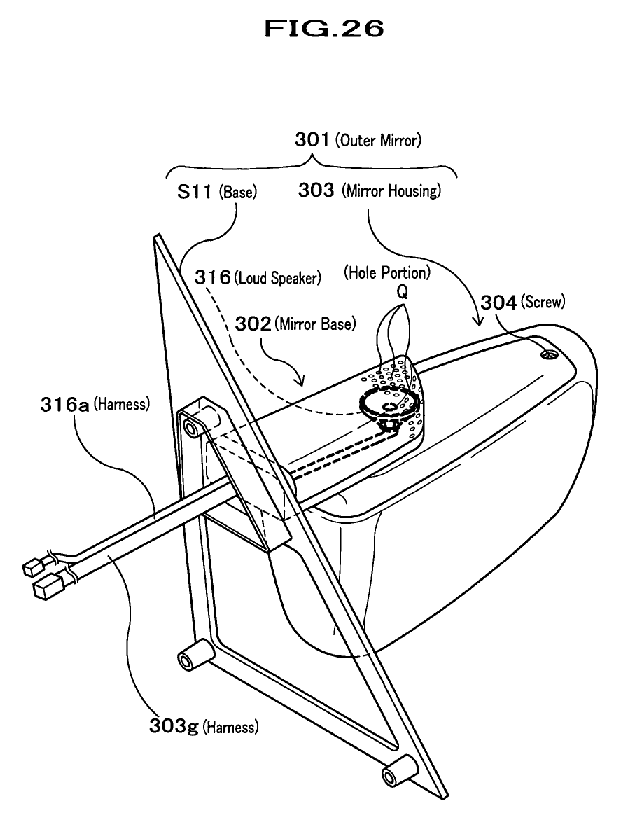

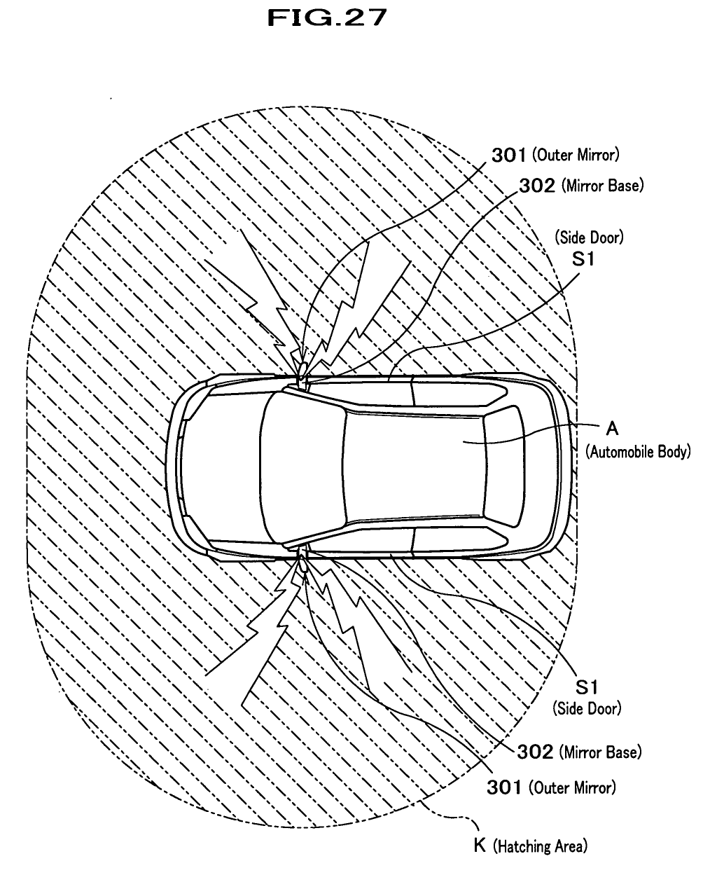

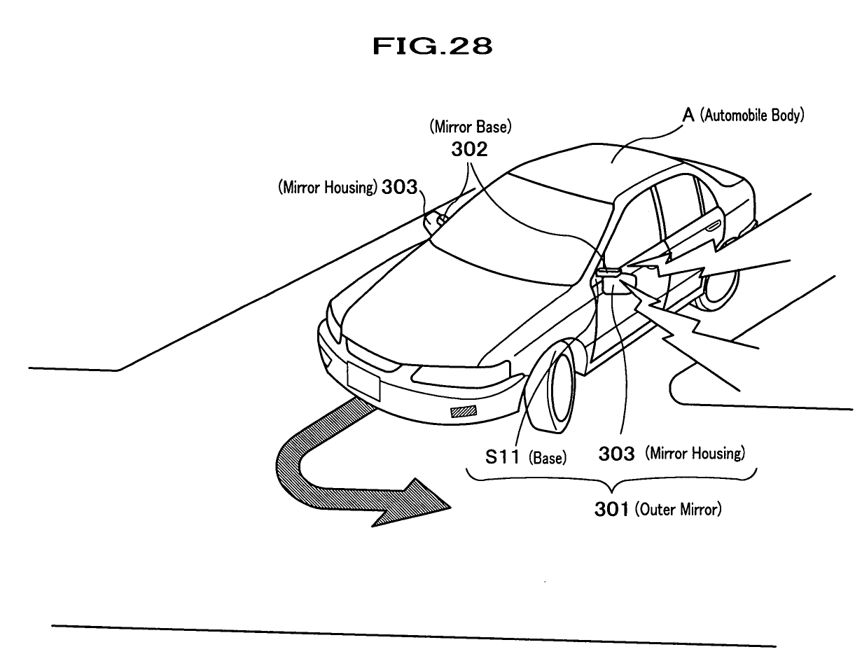

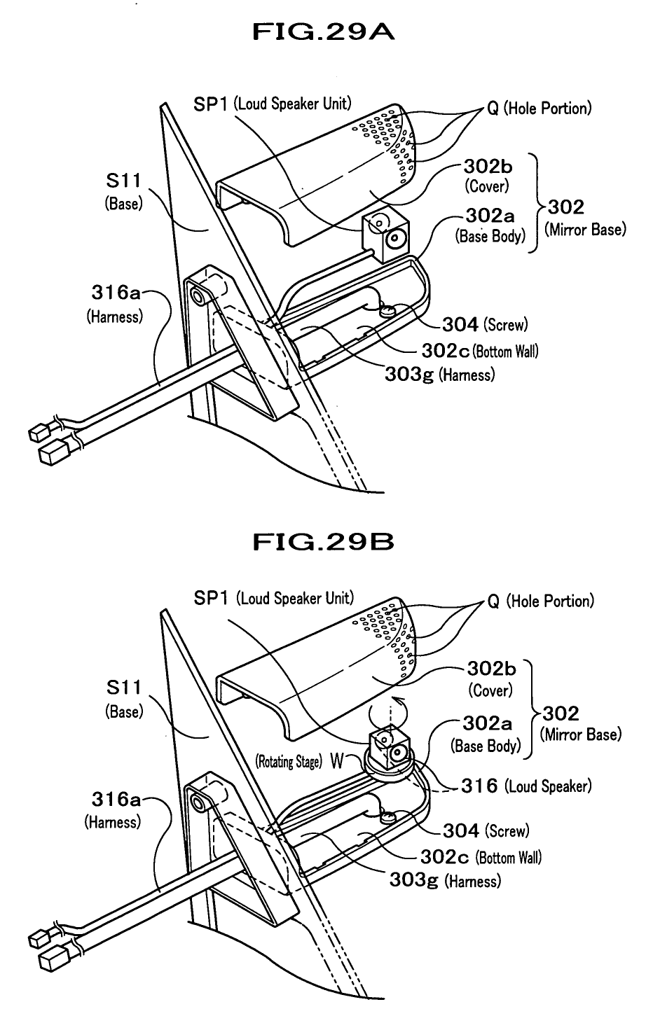

The construction of the outer mirror according to the present embodiment is explained as follows. FIG. 24 is a perspective view of the outer mirror. FIG. 25 is exploded perspective view of the outer mirror. FIG. 26 is a perspective view of the outer mirror wherein a loud speaker is installed in the mirror base. FIG. 27 is a schematic of the audible range of the loud speaker. FIG. 28 is a perspective view showing an example of using the present outer mirror. FIG. 29A is an exploded view of the mirror base wherein two loud speakers are used. FIG. 29b is an exploded view of another implementation of the present embodiment wherein a rotational portion is formed under the loud speaker unit. In this embodiment, the outer mirror is hanged under the mirror base with rotational flexibility. The construction is explained as below.

The outer mirror 301 according to the present embodiment is so-called a door mirror installed on the side door S1 of the automobile body A1, wherein the outer mirror comprises a base S11 which is formed into a single molded body with the mirror base 302 extending outward from the side door and a mirror housing suspended under the single molded body. The outer mirror of the present embodiment is electrically driven to be set back to a housing position and the mirror housing 303 can be freely rotated under the mirror base 302.

The base S11 is made of plastic material in a single molded form with the mirror base 302 extending outward from the side mirror and fixed onto the front portion of the side door S1. The mirror base 302 consists of a base body 302 which can be opened at the upper portion and a cover 302b which covers the upper portion of the base body 302a.

The base body 302a is formed with a bottom wall 302c and a surrounding wall standing from the bottom wall. On the outer portion from the automobile and by the surrounding wall in the bottom wall 302a, a loud speaker 316 is fixed.

The characteristics of the loud speaker are not so specific but a 2 Way type loud speaker that sounds high frequency and the low frequency can generate an alarming sound to the street walkers and the surrounding peoples around the automobile. It is desirable that the loud speaker is designed in waterproof. The harness 316a that supplies the electric power to the loud speaker 316 is lead to the inside of the automobile from the mirror base.

The cover 302b has a hole portion Q which is the outer portion from the automobile and plural holes are opened in the cover 302b. Therefore the sound generated by the loud speaker 316 fixed onto the bottom wall 302c can propagate outward through the hole portion

The harness that supplies electric power to an actuator composing the mirror housing 303 as discussed later and the harness for the loud speaker 316 are lead into the inside of the automobile. The shape of the speaker 316 has no specific forms but is small to be fixed in the hollow room of the mirror base 302 and has a little power consumption as far as the sound should notify the presence of the automobile for the walkers passing by.

The mirror housing 303 comprises the upper housing 303a and the lower housing 303b as shown in FIG. 25 and made of plastic by a mold base. The upper housing comprises a mirror 303c to check the view of the back side and the backward side, an actuator 303d that adjusts the direction of the mirror for upper, lower, left side and the right side and a drive unit 303e that electrically drives the mirror housing 303 to be set back to a housing position. The upper housing 303a and the lower housing 303b are fixed by screws 304.

The outer mirror 301 as constructed as described above can output the sound outward from the loud speaker 316 fixed outer portion of the hole portion Q of the cover 302b of the mirror base 302.

As shown in FIG. 27, once a speaker 316 is equipped with the mirror base 302 of the outer mirror 301 locates in the side door S1 of the driver or the passenger seat of the automobile body A, the sound generated by the loud speaker 16 can propagates in the range as shown in a hatching area K. Therefore, it is possible to notify the waling persons of the presence of the automobile.

As shown in FIG. 28, when the automobile (the automobile body A) is turning left at an intersection, the announcement is possible to the walking person on the street by using the loud speaker installed in the mirror base 302 of the outer mirror 301 attached on the side of the passenger seat (the left side seat) that sounds an announcement of the turning left to him or her. As the result, it is possible to prevent the accident to hit or collide against the walking person. In a similar way, the sounds from the outer mirror 301 attached on the side of the driver can announce the right turning to the walking person. When the automobile takes a back, the announcement by the loud speakers installed in the mirror base 302 of the outer mirror can raise the notice to the walking persons.

As shown in FIG. 29A, a loud speaker unit that includes two loud speakers can be used, wherein the loud speaker unit SP1 is installed in the mirror base 302 and one of the loud speaker in the loud speaker unit is oriented to the forward direction of the automobile and the other loud speaker is oriented to the backward direction. The sounds from both loud speakers can alarm the walking persons surrounding the automobile to be surely notified with the presence of the automobile. Use of plural loud speakers more than two ones may be applied for this embodiment.

As shown in FIG. 29B, a modification of the present embodiment is applied wherein the loud speaker unit SP1 is set on a rotating stage K and the loud speaker unit SP1 can be rotated in one revolution so that sounds are sent to the walking persons surrounding the automobile and notify the presence of the automobile to them.

In the above modification, a loud speaker unit having two loud speakers rotated on the rotating stage According to the outer mirror 301, by using the loud speaker 316 installed in the mirror base 302 that suspends the mirror housing 303 the alarming sound can be generated at the position close to the waking person. Therefore the sound generated by the loud speaker 316 which is necessary to alarm the walking person can be low loud sounds for notifying him or her. Therefore the sounds are lower level that is to be regulated against the quietness in the downtown, especially in the midnight. The low level sound serves the low power consumption of the electronics necessary for the automobile driving. The sounds sent from the loud speaker 316 when the automobile turns to the left or the right or goes back can be surely notified by the waling persons. The loud speakers 316 are installed in the mirror bases attached both sides of the automobile as the driver seat side and the passenger seat side, the sound can be a stereo sound or the effective alarming can be possible due to using the loud speaker closer to the walking person. By using the rotating stage K on which the loud speaker 316 is set, the direction to send the sound can be controlled and directionally selected.

As the result, a most simple implementation such that a loud speaker is installed into the mirror base 302 facilitates to notice the walking person the presence of the automobile, that resultantly suppresses the accident.

As discussed above, the seventh embodiment and the relevant modification have been explained above. The present invention is applied to various modifications for these embodiments as far as the arts are confined within those involved in the scope of the claims.

For example, an upper suspension construction such that the mirror housing 303 is suspended under the mirror base 2 in the outer side from the automobile has been explained in the above embodiment however the lower suspension construction such that the mirror housing 303 is installed on the upper side of the mirror base 302 can serve the same effect with the presentation embodiment.

By making a linkage between the alarming horn and the sounds generated by the loud speaker, it is possible to surely notify the waling person of the presence of the automobile.

In the quiet downtown, the sounds from the speaker 316 can be a pseudo sound of the automobile and can notify the walking person of the presence of automobile.

Instead of using the loud speaker, a buzzer or a piezoelectric element is usable.

In addition to the loud speaker 316, a sound collection means such as a microphone may be installed in the mirror base 302 so that the external sound is transferred to the driver who can listen to the sound in the cabin. For example, the driver can easily get to know the approaching of the emergent vehicles by hearing the external sounds. As the results, he can drive his automobile to a safety zone.

Eighth Embodiment

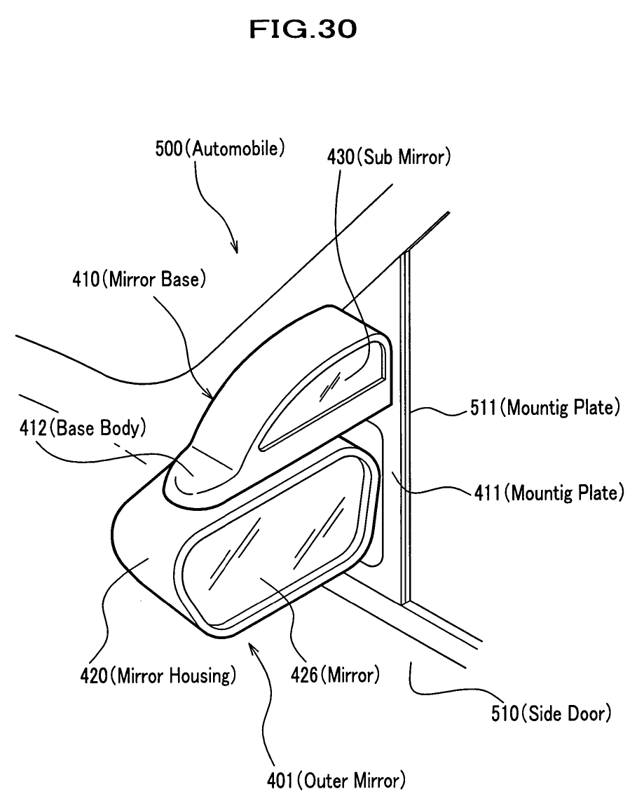

The eighth embodiment is explained by using FIG. 30 to 33.

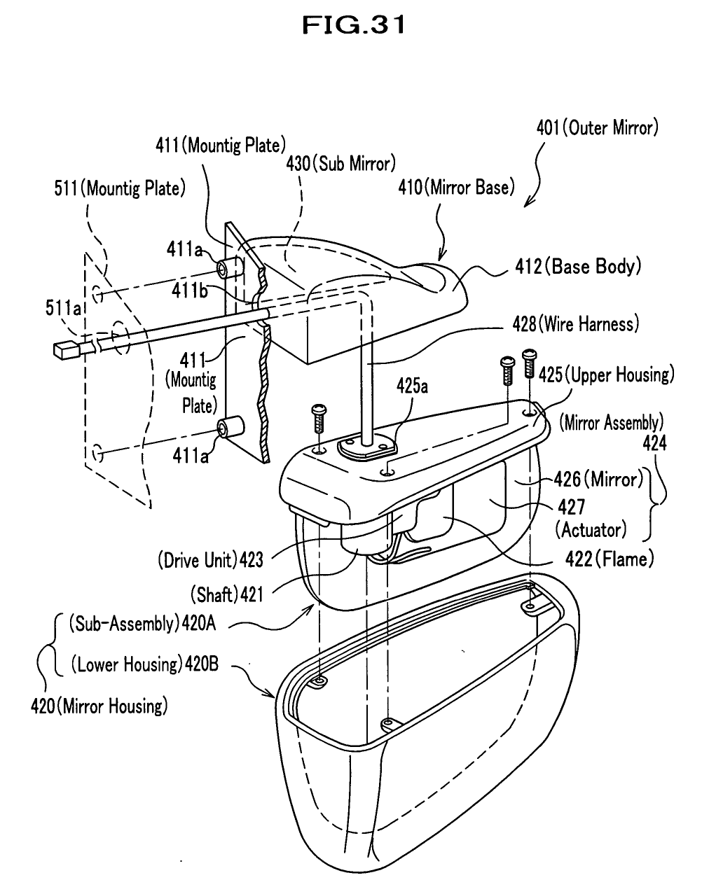

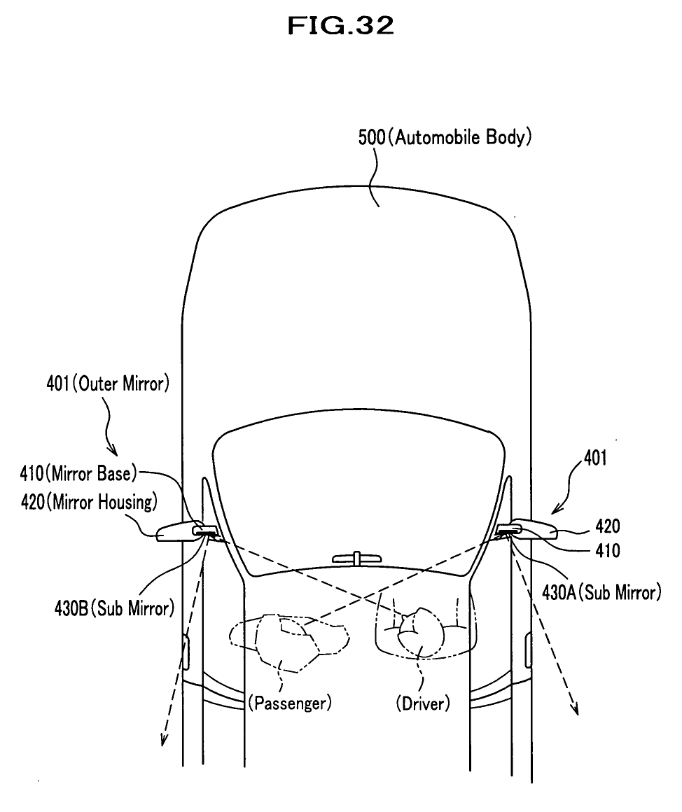

The outer mirror according to the present embodiment is so-called a door mirror and installed onto the side door 5120 of the vehicle 500 using a mounting plate 511. The outer mirror 401 comprises a mirror base 410 extending outward from the side door 510 and a mirror housing 420 suspended under the mirror base 410 as shown in FIG. 30. A sub mirror is attached to the mirror base 410. The detail construction of the outer mirror 401 will be explained by using FIG. 31 and 32.

The mirror base 410 comprises a mounting plate 411 that is to be fixed to a mounting plate 511 (as shown in FIG. 30) formed in the front part of the side door 510 and a base body 412 extending outward from the mounting plate 411 toward out of the side door 510 as shown in FIG. 31. Both the mounting plate 411 and the base body 412 are made into a single molded form of plastic material.

The mounting plate 411 is formed in substantially same shape as the mounting plate 511 of the side door 510. The mounting plate 511 has plurality of bosses of screw hole. The mounting plate 411 can be fixed to another mounting plate 511 by using screw threads from the side of the mounting plate 511. The mounting plate 411 have a cable hole 411b to lead out a wire harness 428 from the base body 412. The wire harness 428 lead out from the cable hole 411b is further lead out to the inside of the automobile 500 through the cable hole 511a.

As shown in FIG. 31, the mirror housing 420 is suspended underneath the base body 421 of the mirror base 410 by a shaft to which the mirror housing is fixed. The top of the shaft 421 is fixed to the bottom of the base body by screws (not shown in the figure). The mirror housing 420 comprises a sub-assembly 420A mounted to the shaft 421 and a lower housing 420B which is covered to the sub assembly 420A from the bottom side. The lower housing is made of hard or rigid plastic. The mirror housing 420B rotates against the mirror base 410 and is designed to be set back to a housing position and reset to resume operation.

The sub-assembly 420A has a frame 422 which is attached to the shaft 421 and a drive unit 423, a mirror assembly 424 and the upper housing 425 is installed into the frame.

The drive unit 423 works as a device so that the mirror housing 420 is rotated around the shaft 421 as a rotating axis and is set back to the housing position and reset to resume operation. The drive unit 423 consists of a motor to generate a driving force and reduction gears equipped with the shaft 421 and the driving force is transmitted to the shaft 421 through the reduction gears. Therefore, the mirror housing 420 can be rotated around the shaft 421. The rotation wise can be selected by the rotation wise of the motor.

The mirror assembly 424 consists of a mirror 426 to view the back side and an actuator 427 to change the direction of the mirror. The actuator 427 has a motor to change the mirror diction in upward or downward and the other motor to change the mirror direction in left ward and the right ward. By controlling the rotation wise of the motor, the direction of the mirror can be changed. The upper housing 425 covers the top area of the lower housing 420B of which top area has an open window 425a into which the shaft 421 of the rotational axis of the mirror housing 420 is involved. The upper housing is made of a rigid plastic.

The lower housing 420B has an open window on the top area and covers the sub-assembly 420A from the bottom side. The lower housing 420B and the upper housing 425 are fixed by screws. The back side of the lower housing 420B has another open window which is the corresponding portion facing against the mirror 426 set in the mirror assembly 424.

The wire harness 428 that supplies the electric power to the driving unit 423 and the actuator 427 of the mirror assembly 424 is set through the axial hole of the shaft. More concretely, the wire harness 428 is set inside the axial hole of the shaft 421 and lead to the inside of the base body 412 of the mirror base 410 and lead out to the inside of the automobile 500 through the cable hole 411b of the mounting plate 411 and the cable hole 511a of the mounting plate 511. The harness 428 is finally connected to a control unit installed in the automobile.

The sub mirror 430 is, as shown in FIG. 30, attached to the back side of the base body 410 of the mirror base 410. The size and the position of the sub mirror may be changed on necessity.

Since the sub mirror 430 is attached to the base body 412 of the mirror base 410, it is not necessary to consider the strength of the shaft 421 against the weight of the mirror housing 420. Therefore it is possible to attach a heavier sub mirror. No resonating vibration is generated in the mirror housing due to the light weight therefore the view on the mirror is clear and no rattling sound is generated so that the comfortable drive is maintained.

The sub mirror 430 is attached to the mirror base 410 and the sub mirror 430 is not set back to the housing position even when the mirror housing 420 is rotated to be set back to the housing position since the sub mirror 430 does not co-rotate with the mirror housing 420 as designed in the conventional mirror housing. Therefore, the sub mirror can be used even when the mirror housing has been set back to the housing position.

Since the mirror housing 420 is suspended under the mirror base 410, the sub mirror 430 is relatively locating upper side of the mirror 426 which is installed in the mirror assembly 424 (as shown in FIG. 31) of the mirror housing 420. Due to the upper position of the sub mirror, the driver can easily see the sub mirror and view the back side by using the sub mirror.

Since the sub mirror 430 is attached to the mirror base 410, the passenger sitting on the passenger seat can see the sub mirror 430A locating at the driver side, the passenger can use the sub mirror 430A (as shown in FIG. 32). In a similar way, the driver can see the sub mirror 430B locating at the passenger seat and the driver can use the sub mirror 430B (as shown in FIG. 32).

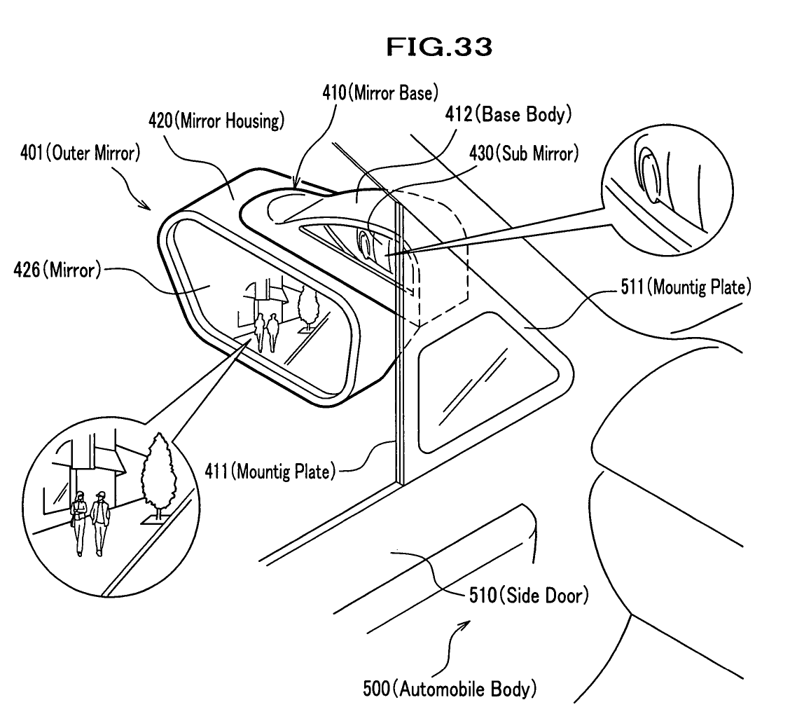

The sub mirrors 430 are suspended by pivot mechanisms installed in the base body 412 of the mirror base 410 and can be adjustably directed in an arbitral direction. In this embodiment, the directional angle of the sub mirror 430 is set such that the driver can see the back wheels relative to the surrounding areas (as shown in FIG. 33). By setting this angle for the sub mirror 430, the driver can easily monitor and check the relative position of the back wheels and the stopping position of automobile against the parking marks.

For the embodiment shown in FIG. 33, the sub mirror 430 is set in an angle so that the driver can easily monitor and check the relative position of the back wheels of the automobile 500. The angle is not limited in this single angle but can be changed to meet the purposes of using the sub mirrors. For example, the angle can be set for the passenger to check the safety of the back side of the automobile and he or she can assist the driver.

The construction of the sub mirror installation in the mirror base is designed to make the angle adjustable and the construction is helpful and convenient for the driver. In the present embodiment, the angle is adjustable by hands but it can be electrically adjustable. For the electrical adjustment, the angle setting of the sub mirror 430 may be designed to be set in a predetermined angle when the driver set the transmission into the back drive. For this design helps the driver to check the stopping position of the automobile at the time of parking.

In order to electrically adjust the angle of the sub mirror 430, a driving motor to adjust the angle of the sub mirror 430 is installed in the base body 412 of the mirror base 410. The wire harness to supply the electric power to the motor is set through a cable hole 411b (see FIG. 33) made in the mounting plate 411 of the mirror base 410 and lead out to the inside of the automobile body 500. Therefore it is not necessary to set the harness through inside of the shaft like as a conventional sub mirror attached to the mirror housing and it can be easier for assembling the sub mirror attached to the mirror base due to no laborious job to set the harness in such a narrow space.

Ninth Embodiment

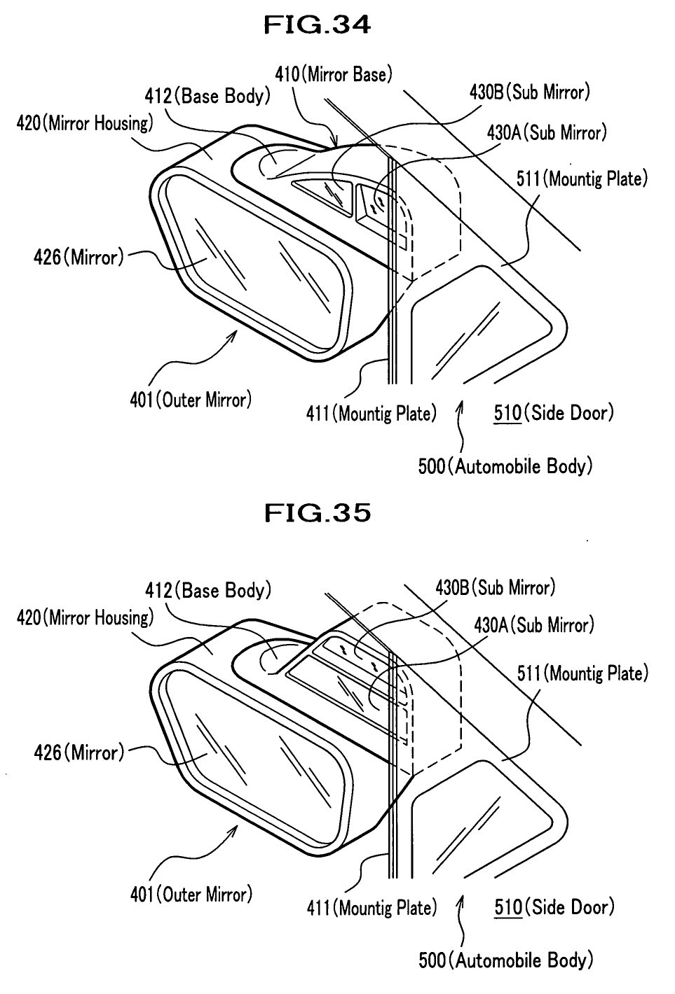

The ninth embodiment will be explained by using FIG. 34 and FIG. 35 as follows. The same parts, components and technologies as those described in the eighth embodiment will be showed with the same codes and signs but not re-explained.

As shown in FIG. 34 and FIG. 35, it may be possible to install plural sub mirrors 440 (450) in the base body 412 of the mirror base 410. Two sub mirrors 440A and 440B are horizontally aligned in side by side in an example of the present embodiment as shown in FIG. 34. Two sub mirrors 440A and 440B are vertically aligned in side by side in an example of the present embodiment as shown in FIG. 35. The upper sub mirror is served for the driver assistance and the lower for the passenger.

Two sub mirrors installed in the base body 412 of the mirror base 410 can be assigned for the use of the driver and use of the passenger in the above examples. These examples allow the dual use of the outer mirror, set in an automobile body 500, which is attached even at the same one side of the automobile.

In the above embodiment, two sub mirrors 440A, 440B (450A, 450B) are assigned for the usage as one for the driver and the other for the passenger. However, it is allowed that the driver or the passer use both two sub mirrors.

The above embodiment is for the case such that two sub mirrors are installed in the base body 412 of the mirror base 410, but three or more sub mirrors can be installed in the base body 412 in accordance with the purposes and the applications.

Tenth Embodiment

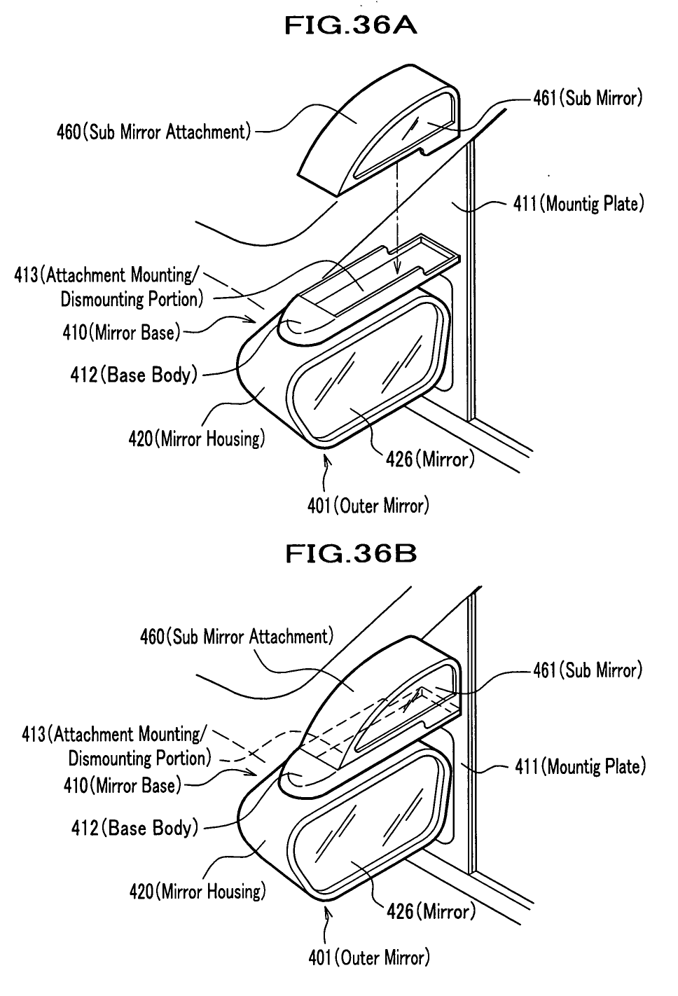

The tenth embodiment of the present invention will be explained by using FIG. 36 to FIG. 40. The same parts, components and technologies as those described in the ninth embodiment will be shown with the same codes and signs but not re-explained.

As shown in FIG. 35A and FIG. 36B, an attachment mounting/dismounting portion is formed so that a sub mirror attachment 460 can be mounted or dismounted to the attachment mounting/dismounting portion 413. It is not limited that only one sub mirror is set in the sub mirror attachment but the plurality of sub mirror are used on necessity. The sub mirror can be arbitrarily adjusted on the mirror setting angle so that an optimum angle is set in accordance with the purposes and the applications.

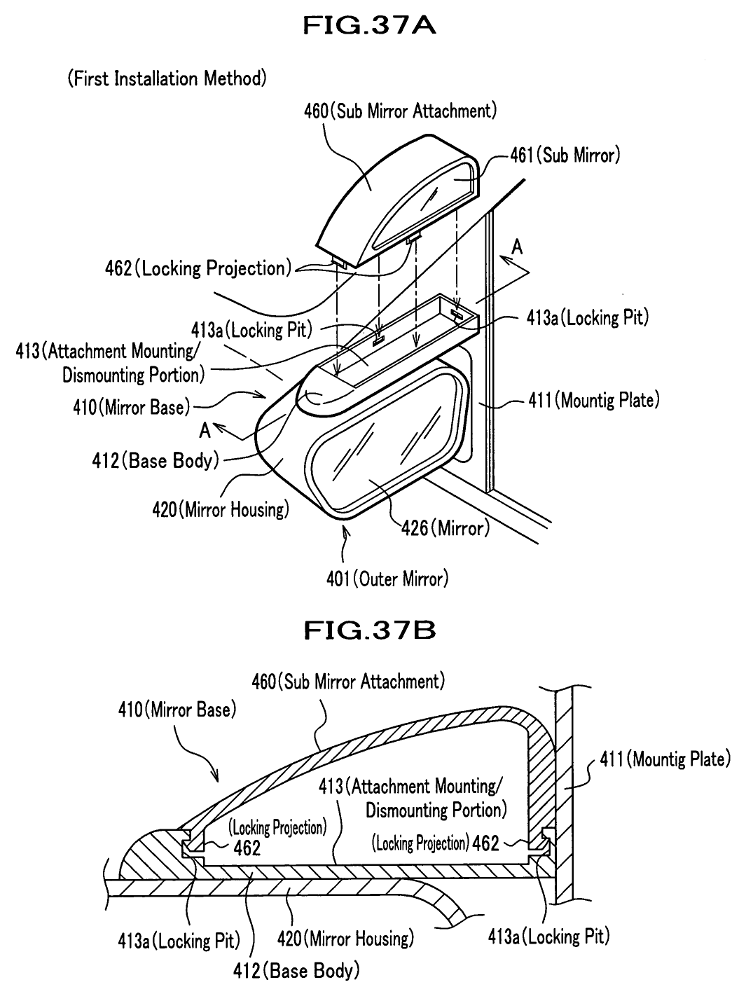

By using this construction, it is possible to dismount the sub mirror from the mirror base 410 if it is not used and mount it only when it is required for use. Various types of sub mirror attachment, such as different quantities of sub mirrors or different external appearance in the attachment portion can be used for the different purposes in variation and option. Several examples of the installation method of the sub mirror attachment are explained (the first installation method to the third installation method) will be explained in accordance with FIG. 37 to FIG. 39.

First Installation Method

As shown in FIG. 37A and FIG. 37B, four locking projections 462 formed around the lower bottom peripheral meet the locking pits 413a made in the side wall of the attachment mounting/dismounting portion 413 and then the sub mirror attachment is fixed to the attached mounting/dismounting portion 413.

In this physical construction and design, the sub mirror attachment 460 can be easily fixed to the attachment mounting/dismounting portion 413.

Second Installation Method

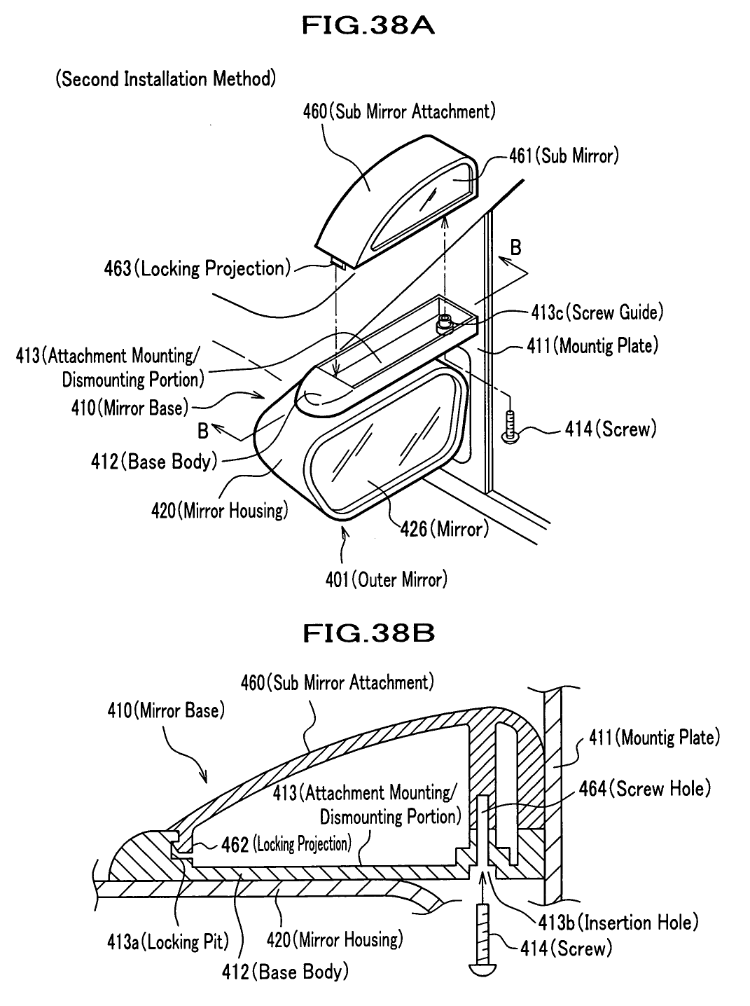

As shown in FIG. 38A and FIG. 38B, a locking projection 463 formed in a sub mirror attachment 460 specifically at the lower peripheral and outer side from the mounting plate 411 is set to a locking pit 413a formed in the attachment mounting/dismounting portion at the wall side being outer from the mounting plate 411 and a screw 414 is screwed into the screw hole 464 of the sub mirror attachment 460 by inserting the screw through the insertion hole 413b formed in the bottom portion of the sub mirror attachment 460. Then the sub mirror attachment is fixed to the attachment mounting/dismounting portion. A screw guide 413c is formed for the purpose of a stand-off to fit to the sub mirror attachment.

In this construction, the fitting of the sub mirror attachment 460 and the attachment mounting/dismounting portion 413 is tighter than in case of the first installation method.

Third Installation Method

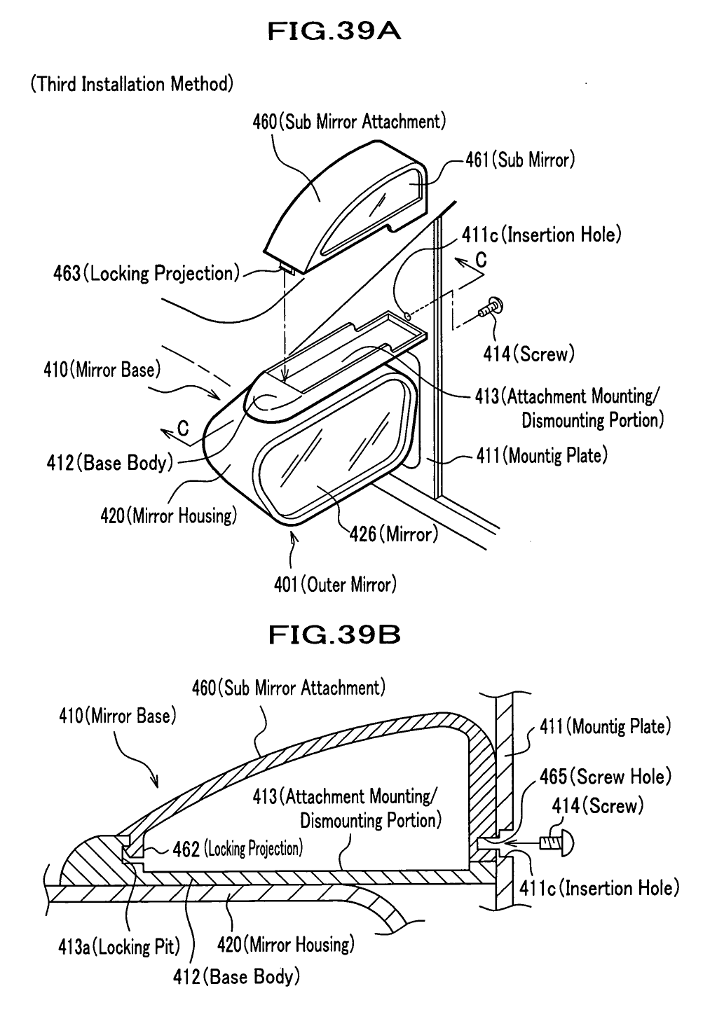

As shown in FGI. 39A and FIG. 39B, a locking projection 463 formed in a sub mirror attachment 460 specifically at the lower peripheral and outer side from the mounting plate 411 is set to a locking pit 413a formed in the attachment mounting/dismounting portion at the wall side being outer from the mounting plate 411 and a screw 414 is screwed into the screw hole 465 through the insertion hole 411c from the mounting plate 411 attached to the automobile body 500.

In this construction, it is not easily to dismount the outer mirror 401 from the mounting plate 511 of the automobile 500 since the sub mirror attachment 460 is fixed by a screw 414 set from the mounting plate. Therefore, it is possible that the sub mirror attachment 460 is prevented to be stolen while parking of the automobile 500.

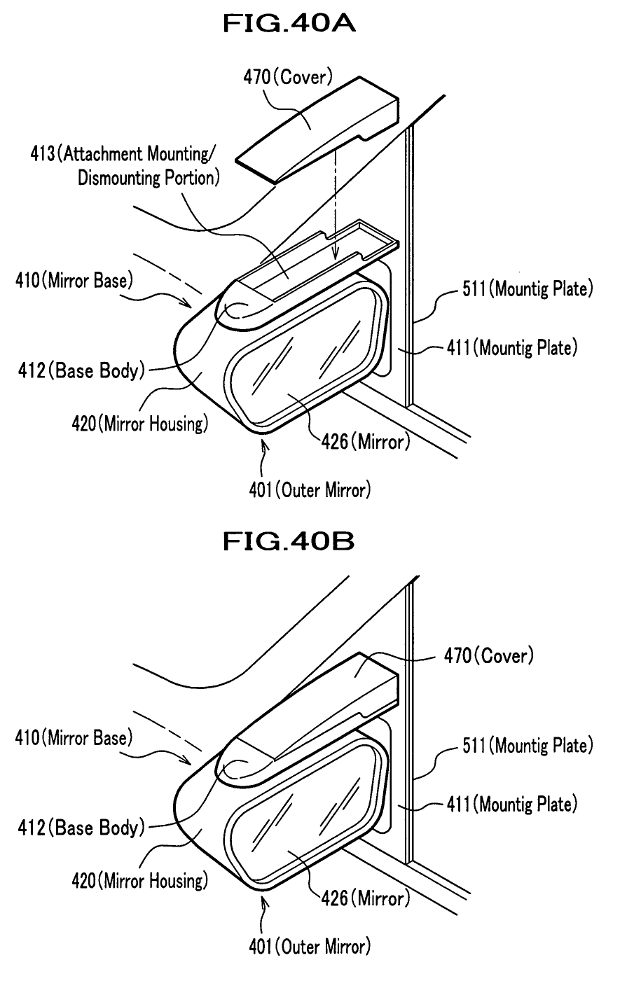

The assembly of the mirror base 410 is explained for the case when the sub mirror attachment is dismounted by using FIG. 40.

As shown in FIG. 40A and FIG. 40B, the sub mirror attachment 460 is dismounted from the attachment mounting/dismounting portion 413 formed on the mirror base 410 and a cover 470 is mounted onto the attachment mounting/dismounting portion 413 when the sub mirror is not used. Then the attachment mounting/dismounting portion is not exposed. Therefore the apparent design is not damaged even the sub mirror attachment is dismounted from the outer mirror.

The above embodiment is about the construction of the mirror base that realized various installations and the case when no sub mirror attachment is used. However other construction such that two sub mirrors are installed in the base body 412 of the mirror base 410 may be possible and various modifications for these embodiments are feasible, as well, as far as the arts are confined within those involved in the scope of the claims.

For example, the outer mirror 401 according to the present embodiment is electrically set back to the housing position. However a manual setting or pre-fixed mirror housing may be used. The dimensions and the shapes of the mirror base 410, the mirror housing 420 and the sub mirror 430 (440, 450, 460 and 461) are not limited to the above examples but can be modified in accordance with the whole design of the automobile.

As explained above, the outer mirror according to the present invention has various advantages. An aspect of these various advantages can be described as; 1) installation flexibility of antenna allows the high performance of radio wave receiving, wide application capability, good apparent design, 2) installation flexibility of electric monitoring camera allows wide scope of monitoring view and wide applications of image monitoring and 3) a compact physical integration of components allows the anti-glare mirror in good serviceability and good apparent design. In addition the present invention facilitates the assembly work of the outer mirror in the assembling process of the automobile manufacturing since the mirror base is used with the outer mirror and the outer mirror assembly can be independent from the automobile body manufacturing. It is possible to raise other advantages in accordance with the applications and purposes in use of the present invention.

What is claimed is:

1. An outer mirror comprising:
a mirror base attached on a side of an automobile and extending outward from said side of said automobile, and
a mirror housing suspended underneath said mirror base in which an antenna unit is installed.

2. An outer mirror as defined in claim 1, wherein, said mirror base has a fixing means that can fix said antenna unit and can adjust a fixing angle of said antenna unit therein.

3. An outer mirror as defined in claim 1, wherein, an electrical connector that is connected to said antenna unit is placed in said mirror base or in said auto mobile specifically in a part adjacent to said mirror base.

4. An outer mirror as defined in claim 2, wherein, an electrical connector that is connected to said antenna unit is placed in said mirror base or in an auto mobile specifically in a part adjacent to said mirror base.

5. An outer mirror as defined in claim 1, wherein, said antenna unit has a capability of receiving a plural radio wave bands.

6. An outer mirror as defined in claim 2, wherein, said antenna unit has a capability of receiving plural radio wave bands.

7. An outer mirror as defined in claim 3, wherein, said antenna unit has a capability of receiving plural radio wave bands.

8. An outer mirror as defined in claim 4, wherein, said antenna unit has a capability of receiving a plural radio wave bands.

9. An outer mirror as defined in claim 1, wherein, said mirror base comprises a base body to which said antenna unit is installed and an outer cover which covers a top of said mirror base and is made of a radio wave transmittable material.

10. An outer mirror as defined in claim 2, wherein, said mirror base comprises a base body to which said antenna unit is installed and an outer cover which covers a top of said mirror base and is made of a radio wave transmittable material.

11. An outer mirror as defined in claim 3, wherein, said mirror base comprises a base body to which said antenna unit is installed and an outer cover which covers a top of said mirror base and is made of a radio wave transmittable material.

12. An outer mirror as defined in claim 4, wherein, said mirror base comprises a base body to which said antenna unit is installed and an outer cover which covers a top of said mirror base and is made of radio wave transmittable material.

13. An outer mirror as defined in claim 5, wherein, said mirror base comprises a base body to which said antenna unit is installed and an outer cover which covers a top of said mirror base and is made of a radio wave transmittable material.

14. An outer mirror as defined in claim 6, wherein, said mirror base comprises a base body to which said antenna unit is installed and an outer cover which covers a top of said mirror base and is made of a radio wave transmittable material.

15. An outer mirror as defined in claim 7, wherein, said mirror base comprises a base body to which said antenna unit is installed and an outer cover which covers a top of said mirror base and is made of a radio wave transmittable material.

16. An outer mirror as defined in claim 8, wherein, said mirror base comprises a base body to which said antenna unit is installed and an outer cover which covers a top of said mirror base and is made of a radio wave transmittable material.

17. An outer mirror as defined in claim 1, wherein, said mirror base comprises a base body to which said antenna unit is installed and an outer cover which covers a top of said mirror base and is made of an infrared light transmittable material or is made of a material of which surface is finished by a material that allows infrared light to transmit through said outer cover.

18. An outer mirror as defined in claim 2, wherein, said mirror base comprises a base body to which said antenna unit is installed and an outer cover which covers a top of said mirror base and is made of an infrared light transmittable material or is made of a material of which surface is finished by a material that allows infrared light to transmit through said outer cover.

19. An outer mirror as defined in claim 3, wherein, said mirror base comprises a base body to which said antenna unit is installed and an outer cover which covers a top of said mirror base and is made of an infrared light transmittable material or is made of a material of which surface is finished by a material that allows infrared light to transmit through said outer cover.

20. An outer mirror as defined in claim 4, wherein, said mirror base comprises a base body to which said antenna unit is installed and an outer cover which covers a top of said mirror base and is made of an infrared light transmittable material or is made of a material of which surface is finished by a material that allows the infrared light to transmit through said outer cover.

21. An outer mirror as defined in claim 17, wherein, an inner surface of said mirror base is frost-painted.

22. An outer mirror as defined in claim 18, wherein, an inner surface of said mirror base is frost-painted.

23. An outer mirror as defined in claim 19, wherein, an inner surface of said mirror base is frost-painted.

24. An outer mirror as defined in claim 20, wherein, an inner surface of said mirror base is frost-painted.

25. An automobile having a pair of outer mirrors as defined in one of claim 1 to claim 24 on both left and right hand sides of said automobile.

26. A surrounding area monitoring device constructed with an outer mirror that comprises:
a mirror base attached on a side of an automobile and extending outward from said side of said automobile, and;
a mirror housing suspended underneath said mirror base in which a viewing camera is installed.

27. A surrounding area monitoring device as defined in claim 26, wherein,
plural viewing cameras are installed in said mirror base.

28. A surrounding area monitoring device as defined in claim 26, wherein,
said viewing camera features to be installed to have a capability of arbitrarily rotation.

29. A surrounding area monitoring device as defined in claim 27, wherein,
said plural viewing cameras feature to be installed to have a capability of arbitrarily rotation.

30. A surrounding area monitoring device as defined in one of claims 26 to claims 29 having said viewing camera attached on an upper surface of said mirror base.

31. A surrounding area monitoring device comprising:
a salient block attached on a side of an automobile and extending outward from said side of said automobile, and;
a viewing cameras installed in said salient block.

32. A surrounding area monitoring device defined in claim 31 or claim 32, wherein,
plural viewing cameras are installed in said salient block.

33. A surrounding area monitoring device defined in claim 31, wherein,
said viewing cameras features to be installed to have a capability of arbitrarily rotation.

34. An automatic anti-glare outer mirror comprising:
a mirror base extending outward from a side of an automobile, and;
a mirror housing, to which an EC mirror of which reflectivity is variable by EC film, attached to said mirror base in which a surrounding light sensor to detect surrounding light and a back side light sensor to detect back side lights are installed, wherein, said automatic anti-glare outer mirror features to have a control means that controls reflectivity of said EC mirror in accordance with said surrounding light detected by said surrounding light sensor and said back side lights detected by said back side light sensor.

35. An automatic anti-glare outer mirror defined in claim 34, wherein,
said control means is installed in said mirror base.

36. An automatic anti-glare outer mirror comprising:
an EC mirror of which reflectivity is variable by EC film, a surrounding light sensor to detect surrounding light and
the back side light sensor to detect back side light, and;
a control means that control the reflectivity of the EC mirrors using sensor signals obtained by a surrounding light sensor and said back side light sensor to detect back side light, wherein, said surrounding light sensor and said back side light sensor are installed in a mirror base which extends outward from a side of an automobile.
